(19) United States
(12) Patent Application Publication
(10) Pub. No.: US 2026/0081940 A1
(43) Pub. Date: Mar. 19, 2026

(54) MALICIOUS ACTIVITY DETECTION BASED ON CHANGES IN A SECURITY GRAPH

(71) Applicant: Microsoft Technology Licensing, LLC, Redmond, WA (US)

(72) Inventors: Moshe ISRAEL, Redmond, WA (US); Andrey KARPOVSKY, Kiryat Motzkin (IL); Fady COPTY, Haifa (IL)

(21) Appl. No.: 18/890,168

(22) Filed: Sep. 19, 2024

(51) Int. Cl. H04L 9/40

(52) U.S. Cl. CPC H04L 63/1425; H04L 63/102; H04L 63/205

(57) ABSTRACT

Systems, methods, and techniques are directed to detecting potential anomalous activity based on changes in a security graph. In an example, a security system receives a first snapshot of a graph representative of a tenant account of a network-based system corresponding to a first timestamp. The security system receives a second snapshot of the graph corresponding to a second timestamp. The security system determines a first change in the graph based on the first and second snapshots and a second change related to the first change. The security system detects a potential anomaly based on the first and second changes. Responsive to detecting a potential anomaly, the security system causes a mitigation step to be performed with respect to the tenant account. In a further example, the security system determines relationships between a sequence of changes satisfies a cumulative anomaly criterion.

### BACKGROUND

Cloud-based systems may be utilized to host computing resources for user accounts. Such a cloud-based system can make services and other resources available for user entities, referred to as “tenants.” A tenant, such as an organization, can have many accounts and resources made available to it. These have gained the interest of malicious entities, such as hackers. Hackers attempt to gain access to a tenant’s computing resources in order to leverage the resources for their own malicious purposes.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Embodiments described herein provide malicious activity detection based on changes in a security graph. For example, a first snapshot of a graph representative of a tenant account of the network-based computing system is received. The first snapshot corresponds to a first timestamp. A second snapshot of the graph corresponding to a second timestamp different from the first timestamp is received. A first change in the graph is determined based on the first and second snapshots. A second change in the graph is determined. The second change is related to the first change. A potential anomaly is detected based on the first and second changes. A mitigation step is caused responsive to the detection of the potential anomaly.

In a further aspect, the graph comprises a first node and a second node.

In a further aspect, the first change is a change in the first node and the second change is a change in the second node related to the change in the first node.

In an alternative aspect, the graph is generated and updated over time.

### BRIEF DESCRIPTION OF THE DRAWINGS/FIGURES

The accompanying drawings, which are incorporated herein and form a part of the specification, illustrate embodiments and, together with the description, further serve to explain the principles of the embodiments and to enable a person skilled in the pertinent art to make and use the embodiments.

FIG. 1 shows a block diagram of an example system for detecting malicious activity based on changes in a security graph, in accordance with an example embodiment.

FIG. 2 shows a block diagram of a system comprising the security system of FIG. 1, in accordance with an example embodiment.

FIG. 3 shows a flowchart of a process for detecting malicious activity based on changes in a security graph, in accordance with an example embodiment.

FIGS. 4A-4C show examples of snapshots of security graphs at different timestamps, in accordance with an example embodiment.

FIG. 5 shows a flowchart of a process for determining changes in a security graph, in accordance with an example embodiment.

FIG. 6 shows a flowchart of a process for determining a severity level of a potential anomaly, in accordance with an example embodiment.

FIG. 7 shows a flowchart of a process for determining changes in a security graph, in accordance with an example embodiment.

FIG. 8 shows an example snapshot of a security graph at a timestamp, in accordance with an example embodiment.

FIG. 9 shows a flowchart of a process for detecting malicious activity based on changes in a security graph, in accordance with an example embodiment.

FIG. 10 shows a flowchart of a process for detecting malicious activity based on changes in a security graph, in accordance with an example embodiment.

FIG. 11 shows a flowchart of a process for detecting malicious activity based on changes in a security graph, in accordance with an example embodiment.

FIG. 12 shows a flowchart of a process for detecting malicious activity based on changes in a security graph, in accordance with an example embodiment.

FIG. 13 shows a block diagram of an example computer system in which embodiments may be implemented.

The subject matter of the present application will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION

### Introduction

The following detailed description discloses numerous example embodiments. The scope of the present patent application is not limited to the disclosed embodiments, but also encompasses combinations of the disclosed embodiments, as well as modifications to the disclosed embodiments. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### Example Embodiments of Malicious Activity Detection

Embodiments of the present disclosure relate to detecting potential malicious activity in computing systems and networked computing systems. Networked computing systems (e.g., cloud computing network systems, enterprise network systems, etc.) make services and other resources available for users. For instance, in a cloud-based system, services and other resources are made available for user entities, referred to as “tenants.” In embodiments, a tenant is an individual user, a group of users, an organization user, and/or the like. In some embodiments, a tenant is associated with multiple “sub-accounts.” For instance, a user group tenant has a user account for each member of the group, in an embodiment. In another example, an organization tenant has a user account for different employees and/or guests of the organization. A tenant, such as an organization, can have many accounts and resources made available to it. These have gained the interest of malicious entities, such as hackers. Hackers attempt to gain access to a tenant’s computing resources in order to leverage the resources for their own malicious purposes.

Detection of malicious activity of malicious entities is an important task for security systems and security users. In some cases, a malicious entity gradually attacks a tenant’s system. For instance, a malicious entity that gains access to a tenant’s account (e.g., through a compromised user account or resource) slowly attacks the tenant account by generating back doors (e.g., other compromised user accounts), evaluating potential data to exfiltrate, gaining access to other resources of the tenant, exfiltrating data, changing permissions, and/or the like. Individually, some of the malicious entity’s activity appears similar to regular activity of the tenant or user accounts of the tenant. A gradual attack of seemingly regular activity assists in obfuscating the attack.

Embodiments of the present disclosure provide techniques for detecting potential malicious activity in computing systems. For example, a security system in an example embodiment receives snapshots of security graphs representative of a tenant account of a network-based computing system at respective timestamps. The security graph, in an implementation, comprises nodes representing resources and/or accounts of the tenant connected by edges that represent relationships between the resources and/or accounts. The security system determines, based on the snapshots, a group of related changes. In some implementations, the group of related changes are changes in a first node and changes in second node dependent on the first. In some cases, there are multiple intermediary nodes and edges between the first and second node. The security system detects a potential anomaly based on the group of related changes and, responsive to detecting the potential anomaly, causes a mitigation step to be performed. In embodiments, a potential anomaly is activity that is a statistically signification action or a statistically significant degree of change that corresponds to anomalous activity. In accordance with an embodiment, a potential anomaly corresponds to a degree of change having a likelihood of indicating anomalous activity that satisfies a predetermined anomaly threshold. By evaluating multiple related changes in a security graph, such security systems are able to identify gradual activity that could indicate a potential attack, even if individual changes appear as normal activity of the tenant. Furthermore, by considering multiple changes, such systems increase confidence that the potential anomaly is anomalous, thereby reducing instances of false positives.

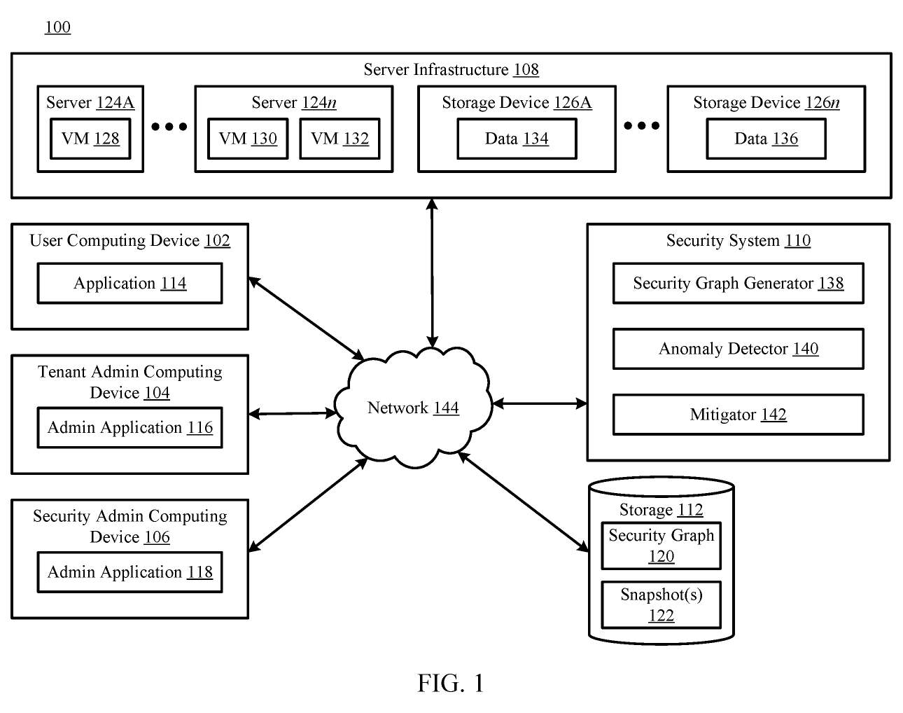

Embodiments are configurable in various ways to detect potential malicious activity based on security graphs. For example, FIG. 1 shows a block diagram of an example system 100 for detecting malicious activity based on changes in a security graph, in accordance with an example embodiment. As shown in FIG. 1, system 100 comprises a user computing device 102, a tenant admin computing device 104, a security admin computing device 106, a server infrastructure 108, a security system 110, and a storage 112, which are communicatively coupled via a network 144. In examples, network 144 comprises one or more networks such as local area networks (LANs), wide area networks (WANs), enterprise networks, the Internet, etc. In examples, network 144 comprises one or more wired and/or wireless portions. The features of system 100 are described in detail as follows.

Server infrastructure 108 is a network-accessible server set (e.g., a cloud-based environment, a cloud-based platform, an enterprise platform, an enterprise environment, and/or the like). As shown in FIG. 1, server infrastructure 108 comprises one or more servers 124A-124n (collectively referred to as “servers 124A-124n”) and one or more storage devices 126A-126n (collectively referred to as “storage devices 126A-126n”). In some embodiments, compute servers (e.g., servers 124A-124n) and/or storage devices are grouped together in a cluster. Servers 124A-124n and storage devices 126A-126n are accessible via network 144.

In an embodiment, one or more of servers 124A-124N and/or storage devices 126A-126n are co-located (e.g., housed in one or more nearby buildings with associated components such as backup power supplies, redundant data communications, environmental controls, etc.) to form a datacenter. For instance, in a non-limiting example, servers 124A-124n and storage devices 126A-126n are located in a datacenter in a distributed collection of datacenters. In accordance with another embodiment, one or more of servers 124A-124n and/or storage devices 126A-126n are arranged in other manners.

In embodiments, each of servers 124A-124n comprise one or more server computers, server systems, and/or computing devices. In embodiments, any (or all) of servers 124A-124n are configured to host and/or otherwise manage one or more assets (e.g., software applications, services, hardware resources), which are utilized by users (e.g., of user computing device 102, tenant admin computing device 104, and/or security admin computing device 106) of the network-accessible server set. For example, as shown in FIG. 1, server 124A executes a virtual machine 128 and server 124n executes virtual machines 130 and 132. In embodiments, servers execute and/or host other assets, such as, but not limited to, serverless functions, machine learning (ML) workspaces (e.g., a group of compute intensive virtual machines for training ML models and/or performing graphics processing intensive tasks), virtual machine scale sets (e.g., distributed across different servers and/or hosted on the same server), storage disks, web applications, database servers, data objects (e.g., data file(s), table(s), structured data, unstructured data, etc.), a cluster (e.g., a cluster of servers and/or other devices), and/or any other type of hardware, software, and/or network resource associated with a user’s computing environment described elsewhere herein.

Storage devices 126A-126n are configured to store data associated with the applications and services managed by servers 124A-124n. In embodiments, each of storage devices 126A-126n comprise one or more server computers, server systems, and/or computing devices. For example, in an implementation, storage devices 126A-126n comprise a respective physical storage disk (or a plurality of physical storage disks) that is accessible via network 144. In some embodiments, one or more of storage devices 126A-126n are integrated on one or more of servers 124A-124n.

User computing device 102, tenant admin computing device 104, and security admin computing device 106 are each any type of stationary or mobile processing device, including, but not limited to, a desktop computer, a server, a mobile or handheld device (e.g., a tablet, a personal data assistant (PDA), a smart phone, a laptop, etc.), an Internet-of-Things (IoT) device, etc. In accordance with an embodiment, user computing device 102 is associated with a user (e.g., an individual user, a group of users, an organization, a family user, a customer user, an employee user, a tenant, etc.). In an embodiment, the user of user computing device 102 is a member of a tenant associated with tenant admin computing device 104 (e.g., an employee of a tenant organization). In an alternative embodiment, the user of user computing device 102 is a malicious entity (e.g., a hacker) that has infiltrated the tenant organization’s resources. User computing device 102 is configured to execute an application 114. In accordance with an embodiment, application 114 enables a user to interface with server infrastructure 108 and/or security system 110, e.g., to create assets, to manage assets, to remove assets, to utilize assets, to receive output from security system 110, to manage privileges of a user account of the user, to create user accounts of the tenant, and/or the like.

In accordance with an embodiment, tenant admin computing device 104 is associated with a tenant of a network-based system associated with server infrastructure 108 (e.g., a customer organization of a service provider that provides services and/or resources of server infrastructure 108, a managing entity (e.g., user or organization) that manages resources hosted by server infrastructure 108, a customer group (e.g., of users) that receives services provided by the service provider of server infrastructure 108, and/or the like). In an embodiment, tenant admin computing device 104 is associated with an admin user (e.g., an individual admin user (e.g., a developer, a system administrator, a service team user, a management user), a group of admin users, etc.) of a tenant. Tenant admin computing device 104 is configured to execute an admin application 116. In accordance with an embodiment, admin application 116 enables an admin user to interface with user computing device 102, security admin computing device 106, server infrastructure 108, and/or security system 110, e.g., to configure and/or otherwise manage resources of server infrastructure 108 that are associated with a tenant account of the tenant organization, to transmit communication to and/or receive communication from user computing device 102 and/or security admin computing device 106, to receive output from security system 110, to manage access to resources of the tenant account, and/or the like.

In accordance with an embodiment, security admin computing device 106 is associated with an admin user (e.g., an individual admin user (e.g., a developer, a system administrator, a service team user, a management user), a group of admin users, a service provider (and/or employees thereof), etc.). In an embodiment, the admin user of security admin computing device 106 is associated with the service provider of server infrastructure 108. Alternatively, the admin user of security admin computing device 106 is associated with a third party security service provider that provides security services for the tenant of tenant admin computing device 106 and/or the service provider of server infrastructure 108. Security admin computing device 106 is configured to execute an admin application 118. In accordance with an embodiment, admin application 118 enables an admin user to interface with user computing device 102, tenant admin computing device 104, server infrastructure 108, security system 110, and/or storage 112, e.g., to configure and/or otherwise manage security system 110, to manage server infrastructure 108, to transmit communication to and/or receive communication from user computing device 102 and/or tenant admin computing device 104, to access data stored in storage 112, and/or the like.

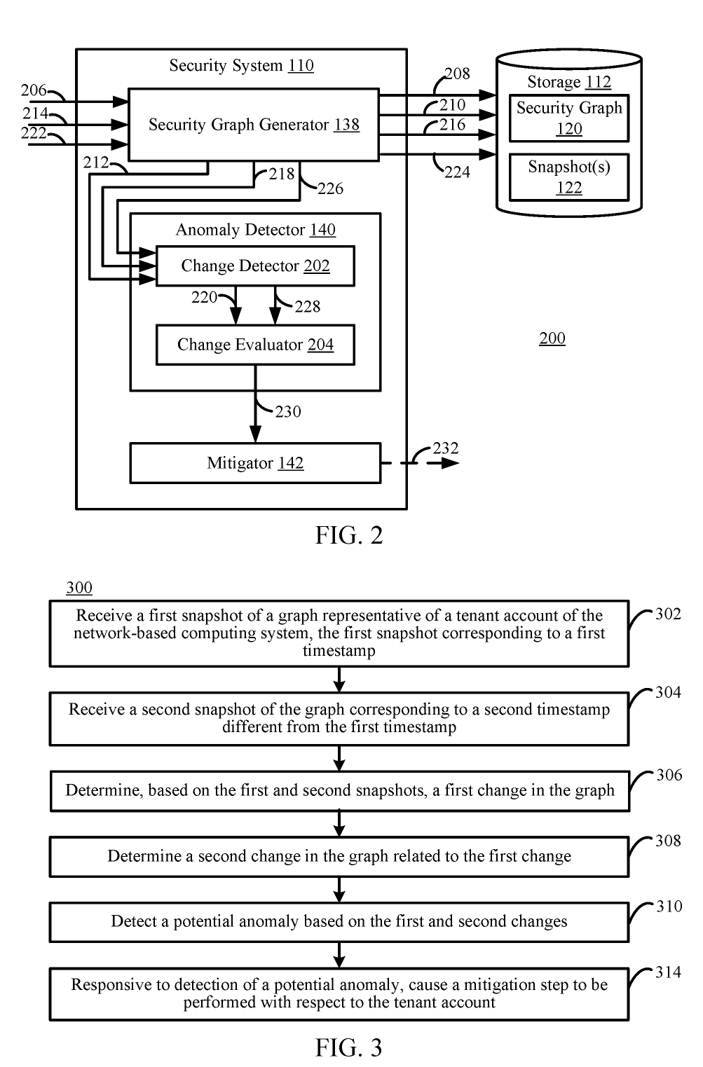

Storage 112 comprises a database, a data store, one or more memory devices and/or the like for storing data. For example, as shown in FIG. 1, storage 112 stores a security graph 120 and one or more snapshots 122 (“snapshots 122”). In accordance with an embodiment, security graph 120 represents a tenant account of a network-based computing system (e.g., the tenant associated with tenant admin computing device 104). In an implementation, the security graph includes nodes representing resources and/or devices associated with the tenant and edges connecting two or more nodes. In an embodiment, an edge represents a potential attack path or other association between a first node and a second node. In embodiments, storage 112 stores respective security graphs for multiple tenants. Snapshots 122 comprise representations of security graph 120 at a particular timestamp. For example, in accordance with an embodiment, snapshots 122 comprises a first snapshot of security graph 120 at a first timestamp, a second snapshot of security graph 120 at a second timestamp different from the first timestamp, and a third snapshot of security graph 120 at a third timestamp different from the first and second timestamps. Additional details regarding security graphs and snapshots of security graphs are described with respect to FIGS. 2-12, as well as elsewhere herein. As shown in FIG. 1, storage 112 is separate from user computing device 102, tenant admin computing device 104, security admin computing device 106, server infrastructure 108, and security system 110. In an alternative embodiment, some or all of storage 112 is implemented in user computing device 102, tenant admin computing device 104, security admin computing device 106, server infrastructure 108, and/or security system 110. For example, in accordance with an embodiment, storage 112 is integrated in security system 110.

Security system 110 comprises one or more computing devices and is configured to monitor server infrastructure 108 and activity with respect to server infrastructure 108 to detect potential malicious activity. As shown in FIG. 1, security system 110 comprises a security graph generator 138, an anomaly detector 140, and a mitigator 142, each of which are implemented as sub-components of and/or sub-services executed by security system 110. Security graph generator 138 is configured to generate a security graph representative of a tenant of system 100 and its resources. For example, in accordance with an embodiment, security graph generator 138 generates a security graph representative of the tenant associated with tenant admin computing device 104 and its associated resources. In an embodiment, security graph generator 138 generates and/or updates the security graph periodically by obtaining a status of and properties of resources assigned to the tenant. Alternatively, a telemetry or other monitoring service/device (not shown in FIG. 1) provides updated information to security graph generator 138 every time there is a change in the tenant account, its resources, and/or its associated accounts (e.g., user accounts and/or the like). Example resources include, but are not limited to, assets of server infrastructure 108 assigned to the tenant (e.g., virtual machines 128, 130, and/or 132), data stored by a storage device of server infrastructure 108 on behalf of the tenant (e.g., data 134 and/or data 136), a data store or other type of storage that the tenant has access to (e.g., storage device 126A and/or storage device 126n), applications executed on behalf of the tenant, and/or other resources of a network-based system assigned to the tenant. In accordance with an embodiment, security graph generator 138 includes accounts of the tenant account, subscriptions associated with the tenant, and/or users associated with the tenant (e.g., a user account of the user associated with user computing device 102) in the security graph. In accordance with an embodiment, security graph generator 138 includes devices external to server infrastructure 108 that have access to resources of the tenant, e.g., user computing device 102 and/or tenant admin computing device 104. In accordance with an embodiment, security graph generator 138 stores the security graph as security graph 120 in storage 112.

In some embodiments, security graph generator 138 generates snapshots of a security graph. In embodiments, a snapshot is a representation of a security graph at a particular timestamp. In some implementations, security graph generator 138 provides the snapshot to anomaly detector 140 for evaluation thereof. In accordance with an embodiment, security graph generator 138 stores a generated snapshot in storage 112 as a snapshot of snapshots 122.

Anomaly detector 140 is configured to detect anomalies based on changes in a security graph (e.g., security graph 120). In accordance with an embodiment, anomaly detector 140 monitors a security graph to detect changes over time. Alternatively, anomaly detector 140 receives snapshots of the security graph corresponding to different timestamps and determines changes in the graph based on the snapshots. Anomaly detector 140 determines if a change evidences a potential anomaly, which could indicate potential malicious activity (e.g., a potential attack by a hacker, a potential data exfiltration attack, and/or the like). In embodiments, anomaly detector 140 provides an indication of the potential anomaly to mitigator 142.

Mitigator 142 is configured to mitigate potential anomalous activity responsive to anomaly detector 140 detecting a potential anomaly. Depending on the implementation, mitigator 142 generates an alert indicative of the potential anomaly and transmits the alert to a tenant, a user impacted by the potential anomaly, and/or a security admin user. In some implementations, mitigator 142 implements an automatic mitigation step. Example automatic mitigation steps include, but are not limited to, restricting access of a user account and/or a resource, implementing a multi-factor authentication protocol, requesting a user provide a password or other secret (e.g., an answer to a security question, a code sent to their mobile device, and/or the like) to proceed with an operation, isolating a device and/or resource, deactivating or suspending a user account, and/or the like.

Implementations of security system 110 are configurable in various ways to detect potential anomalies and perform mitigation steps with respect to potential anomalies. For example, FIG. 2 shows a block diagram of a system 200 comprising security system 110 of FIG. 1, in accordance with an example embodiment. As shown in FIG. 2, system 200 also comprises storage 112 (comprising security graph 120 and snapshots 122), as described with respect to FIG. 1. As also shown in FIG. 2, security system 110 comprises security graph generator 138, anomaly detector 140, and mitigator 142, as respectively described with respect to FIG. 1. Anomaly detector 140 comprises a change detector 202 and a change evaluator 204, each of which are implemented as sub-components of and/or sub-services of anomaly detector 140.

To better understand the operation of security system 110 of FIG. 2, FIG. 2 is described with respect to FIG. 3. FIG. 3 shows a flowchart 300 of a process for detecting malicious activity based on changes in a security graph, in accordance with an example embodiment. In an embodiment, anomaly detector 140 operates according to the steps of flowchart 300. Note that not all steps of flowchart 300 need be performed in all embodiments. Further structural and operational embodiments will be apparent to persons skilled in the relevant art(s) based on the following descriptions of FIGS. 2 and 3.

Flowchart 300 begins with step 302. In step 302, a first snapshot of a graph representative of a tenant account of the network-based computing system is received, the first snapshot corresponding to a first timestamp. For example, change detector 202 of FIG. 2 receives a first snapshot 212 (“snapshot 212”). As shown in FIG. 2, change detector 202 receives snapshot 212 from security graph generator 138. In accordance with an embodiment, security graph generator 138 generates snapshot 212 based on tenant data 206. Tenant data 206 represents user accounts of a tenant account, resources of the tenant account (e.g., virtual machines, devices, storage devices, applications, and/or other cloud assigned to and/or otherwise associated with the tenant account), activity of the tenant account and/or a user account thereof, and/or any other information associated with the tenant account. In accordance with an embodiment, tenant data 206 is streamed to security graph generator 138 (e.g., from a monitoring and/or telemetry system, not shown in FIG. 2). In accordance with another embodiment, tenant data 206 is provided to security graph generator 138 on a periodic basis (e.g., from a monitoring and/or telemetry system). In accordance with another embodiment, security graph generator 138 obtains tenant data 206, e.g., from a monitoring and/or telemetry system, from a data store that stores tenant data, from measuring the tenant account’s resources. In embodiments, security graph generator 138 generates security graph 120 based on tenant data 206. As shown in FIG. 2, security graph generator 138 stores security graph 120 in storage 112 via storage signal 208. In some embodiments, and as also shown in FIG. 2, security generator 138 stores snapshots of security graph 120 at a particular timestamp in storage 112 as one of snapshots 122. For example, security graph generator 138 stores snapshot 212 (at a timestamp t₁ ) in storage 112 via storage signal 210. In some embodiments, change detector 202 receives (or otherwise obtains) snapshot 212 from storage 112.

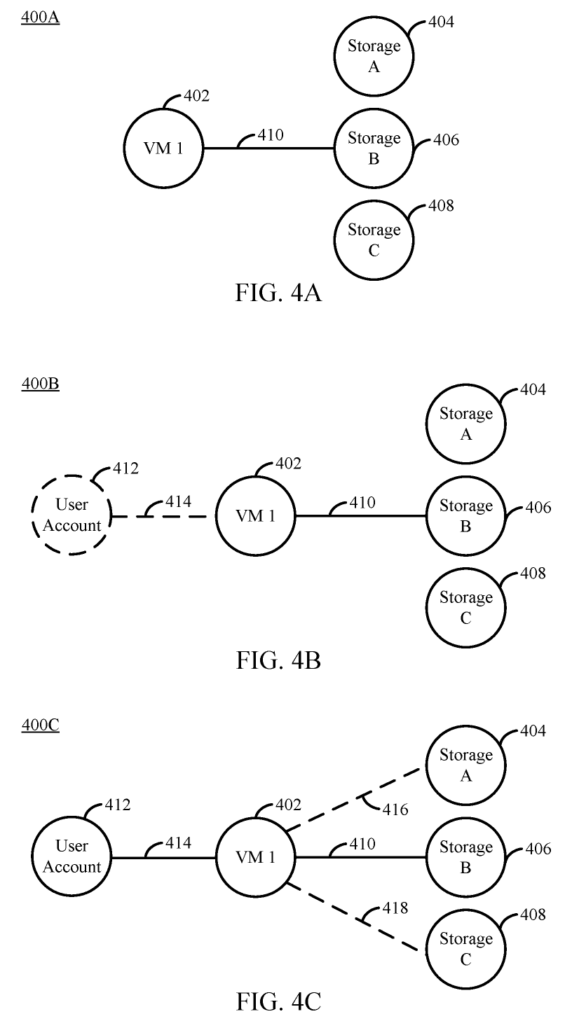

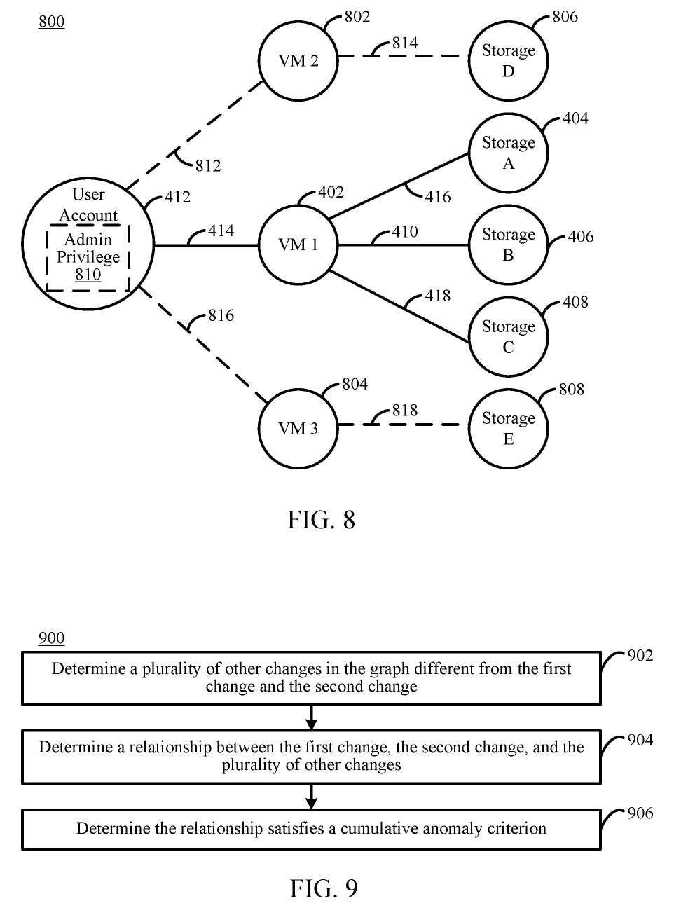

Security graph generator 138 generates security graph 120 and/or snapshots thereof (e.g., snapshot 212) in various ways. For example, in accordance with an embodiment, security graph generator 138 generates security graph 120 by representing user accounts and resources as nodes of the graph. Security graph generator 138 generates edges that connect one node to another node based on a relationship between resources and/or accounts represented by the node. For instance, if a user account has access to a resource, security graph generator 138 generates an edge that connects a node representative of the user account to a node representative of the resource. In some embodiments, an edge indicates flow of data (e.g., read-only access, write-only access, read and write access). Examples of security graphs comprising nodes and edges are described with respect to FIGS. 4A-4C and FIG. 8, as well as elsewhere herein.

In step 304, a second snapshot of the graph corresponding to a second timestamp different from the first timestamp is received. For example, change detector 202 of FIG. 2 receives a second snapshot 218 (“snapshot 218”) from security graph generator 138. Snapshot 218 is a snapshot of security graph 120 at a timestamp t 2 different from t 1. In some embodiments, change detector 202 receives (or otherwise obtains) snapshot 218 from snapshots 122 of storage 112. Alternatively, and as shown in FIG. 2, change detector 202 receives snapshot 218 from security graph generator 138. Security graph generator 138 generates snapshot 218 in a similar manner to snapshot 212. For instance, as shown in FIG. 2, security graph generator 138 receives tenant data 214 (e.g., in a similar manner as tenant data 214) and generates snapshot 218 by updating security graph 120 based on tenant data 214. Alternatively, security graph generator 138 generates a new security graph from tenant data 214 (e.g., without having to determine changes between security graph 120 and the new graph). As shown in FIG. 2, security graph generator 138 (in some embodiments) stores snapshot 218 in storage 112 as one of snapshots 122 via storage signal 216. In some embodiments, security graph generator 138 updates the stored version of security graph 120 and/or overwrites security graph 120 with a new security graph.

In step 306, a first change in the graph is determined based on the first and second snapshots. For example, change detector 202 of FIG. 2 determines a first change in security graph 120 based on snapshot 212 and snapshot 218. In accordance with an embodiment, change detector 202 determines changes based on embeddings of snapshot 212 and 218. In this context, change detector 202 comprises an embedding model and/or utilizes an external embedding model configured to generate embeddings that semantically represent features of snapshot 212 (e.g., resources of the tenant account, relationships between the resources (e.g., dependencies, access policies, and/or the like), properties of resources (e.g., creation dates, functions, applications executed by, access policies applied to, secrets, stored data of, and/or the like), user accounts of the tenant account, properties of user accounts (e.g., user information of a user associated therewith, permissions thereof, an account type thereof, and/or the like), relationships between user accounts, relationships between user accounts and resources, and/or the like). In accordance with an embodiment, embeddings of snapshots represent features in vector space in a manner that a distance between snapshots in the vector space represents a semantic similarity of the two snapshots. For example, if snapshot 212 is close to snapshot 218 in vector space, there are fewer changes in the tenant account than if snapshot 212 and snapshot 218 are further apart in vector space. In accordance with an embodiment, change detector 202 determines there is a change in a node and/or an edge if the distance between embeddings of snapshot 212 and snapshot 218 (or a component of snapshots 212 and 218 or multiple components of snapshots 212 and 218) in vector space satisfies a predetermined change threshold.

In some embodiments, change detector 202 determines changes between snapshots in ways other than (or in addition to) a comparison of embeddings. For example, in accordance with an embodiment, change detector 202 performs an image comparison technique between a graphic representation of snapshot 212 and a graphic representation of snapshot 218. In an example of this alternative, change detector 202 determines a change in the graph, a node of the graph, and/or an edge of the graph based on a percentage of graphic differences between the graphic representations of snapshots 212 and 218 satisfying a predetermined change threshold. In accordance with an alternative embodiment, change detector 202 compares text of resources, accounts, and/or relationships of snapshots 212 and 218 to determine changes. In this context, change detector 202 determines a change in the graph, a node of the graph, and/or an edge of the graph based on any change in the text and/or an amount of text (e.g., a percentage of text a number of added text, a number of deleted text, a combination of amount of deleted and added text, and/or the like) satisfying a predetermined change threshold. In accordance with another embodiment, change detector 202 compares features of a resource in snapshot 212 with features of the same resource in snapshot 212 to determine changes in the resource. In examples of this alternative embodiment, change detector 202 determines if any feature of a resource has changed and/or if a number of features of a resource (or multiple resources) that have changed satisfies a predetermined change threshold.

Several embodiments of change detector 202 have been described herein with respect to determining if a measurement of change (e.g., via graphic comparison, via textual comparison, via embedding comparison, and/or the like) satisfies a predetermined change threshold. In accordance with an embodiment, the predetermined change threshold is set such that a single change (e.g., a single change in embeddings, a single change in a graphic image, a single change in text, a single change in a feature, and/or the like) in between snapshots satisfies the threshold. In another embodiment, the predetermined change threshold is set such that multiple changes in the snapshots satisfy the threshold. In embodiments, the predetermined change threshold is a default number, a number determined by a security admin user (e.g., of security admin computing device 106), a number determined tenant admin user (e.g., of tenant admin computing device 104), a number determined by a security policy, and/or the like.

In accordance with an embodiment, and as shown in FIG. 2, change detector 202 generates a change indication 220 that indicates changes between snapshots 212 and 218. Depending on the implementation, change indication 220 comprises a list of changes, a degree of one change to another, a score representative of semantic similarity between snapshots 212 and 218, and/or the like. In some embodiments, change indication 220 comprises a status update of other resources, accounts, and/or relationships of the tenant account (e.g., including those that had no change). As shown in FIG. 2, change detector 202 provides change indication 220 to change evaluator 204.

In step 308, a second change in the graph related to the first change is determined. For example, change detector 202 determines a second change in security graph 120. The second change is related to the first change. Depending on the implementation (and/or scenario), change detector 202 determines the second change related to the first based on the same snapshots (e.g., snapshots 212 and 218) or different (e.g., subsequent, prior, and/or otherwise different) snapshots (e.g., snapshot 218 and a third snapshot different from to snapshots 212 and 218 or two snapshots different from snapshots 212 and 218). For example, as shown in FIG. 2, change detector 202 receives a snapshot 226 from security graph generator 138. Snapshot 226 is generated in a similar manner as snapshots 212 and 218 (e.g., generated based on tenant data 222 and/or stored in storage 112 as one of snapshots 122 via storage signal 224). Snapshot 226 is a snapshot of security graph 120 at a timestamp t₃ different from t₁ and t₂. In an embodiment, change detector 202 determines a change in security graph 120 based on snapshots 218 and 226 and generates a change indication 228 indicating the change. As shown in FIG. 2, change detector 202 provides change indication 228 to change evaluator 204.

Change detector 202 determines the second change in security graph 120 in a similar manner to the first change is determined as described with respect to step 306. In embodiments, change detector 202 utilizes the same or a different technique for determining the second change as the technique utilized for determining the first change. In embodiments where the first change is determined based on a predetermined change threshold, embodiments of change detector 202 determine the second change based on the same predetermined change threshold. Alternatively, some embodiments of change detector 202 determine the second change based on a different predetermined change threshold from the threshold utilized to determine the first change.

As described above, the second change is related to the first change. A relationship between the changes is determined in various ways, depending on the implementation. In some embodiments, change detector 202 determines the second change is related to the first change. Alternatively, and as described further with respect to step 310, change evaluator 204 determines the second change is related to the first change.

In step 310, a potential anomaly is detected based on the first and second changes. For example, change evaluator 204 detects a potential anomaly based on the first and second changes. In accordance with an embodiment, change evaluator 204 detects the potential anomaly based on change indication 220 (i.e., where change indication 220 indicates the first and second changes). Alternatively, change evaluator 204 detects the potential anomaly based on multiple change indications (e.g., change indications 220 and 228) (i.e., where the first change is detected based on two snapshots and the second change is detected based on at least one different snapshot). In accordance with an embodiment, change evaluator 204 utilizes a graph-based metric to detect the potential anomaly. For example, change evaluator 204 evaluates a change in the blast radius of a user account and/or resource between multiple snapshots. A blast radius is a representation of potential damage that can occur if a security breach or failure happens with respect to the user account and/or resource. For instance, suppose change indication 220 indicates a blast radius of a user account is a first number and change indication indicates the blast radius of the user account is a second number greater than the first. In an embodiment, change evaluator 204 determines the difference between the first number and the second number satisfies an anomaly condition (e.g., exceeds a blast radius anomaly threshold). In this context, change evaluator 204 determines changes in the tenant account have occurred (e.g., at a rapid pace) that expose the tenant account and/or its secrets to a potential malicious attack. In accordance with an embodiment, the anomaly condition is specified by a configuration of the tenant account (e.g., a default setting, set by admin application 116, set by admin application 118, and/or the like).

Change evaluator 204, in some embodiments, evaluates various graph-based metrics to detect potential anomalies (e.g., in lieu of or in addition to blast radius). For instance, in accordance with an embodiment, change evaluator 204 evaluates subgraph connectivity of nodes of security graph 120 and changes in the subgraph connectivity. For example, suppose change evaluator 204 detects an increase in connectivity of a storage device and virtual machine resources and user accounts. This change could represent an attacker generating multiple attack paths to the storage device (e.g., back doors to the storage device) in case one attack path is remedied. In another embodiment, and as described further with respect to FIG. 4C, change evaluator 204 detects an increase in connections between a resource and storage devices. This activity could indicate an attacker is leveraging a resource they have access to (e.g., a virtual machine) to access multiple storage devices. In accordance with another embodiment, and as described further with respect to FIGS. 8 and 9, change evaluator 204 detects an increase in connections between a user account and resources of the tenant account. This activity could indicate an attacker is increasing the access of a compromised account. In accordance with another embodiment, change evaluator 204 detects an increase in connections between a resource and multiple user accounts. This activity could indicate an attacker is increasing back door access to a resource if one of the compromised accounts is detected and locked out (e.g., by creating multiple compromised accounts).

Change evaluator 204, in embodiments, evaluates changes to determine potential anomalies; however, depending on the scenario an individual change could represent normal activity. For instance, suppose change evaluator 204 evaluates the first change in subgraph 120 and determines the change indicates a new account being granted access to a set of resources. While this change could indicate an attack, it could also indicate a normal user (e.g., a new hire or a new team member) being granted access to resources the tenant intends the user to have access to (e.g., a team member being granted access to resources shared by their team as well as resources of the individual team member). In order to determine if the first change is a potential anomaly, embodiments of change evaluator 204 evaluate changes related to subgraph 120 that are related to the first change. For instance, if the first change indicates a change in a first node of subgraph 120, change evaluator 204 evaluates changes to other nodes related to the first node (e.g., a second connected to the first node by a first edge (e.g., a direct relationship), a third node connected to first node through a series of other nodes and edges (e.g., an indirect relationship), and/or the like). By considering multiple related changes in determining a potential anomaly, change evaluator 204 is able to detect potential anomalies that would otherwise go unnoticed. Furthermore, such operation by change evaluator 204 increases the confidence in whether or not the detected potential anomaly is indicative of an attack.

In step 312, responsive to detection of a potential anomaly, a mitigation step is caused to be performed with respect to the tenant account. For example, change evaluator 204 of FIG. 2 causes mitigator 142 to perform a mitigation step responsive to detecting the potential anomaly. As shown in FIG. 2, change evaluator 204 causes mitigator 142 to perform the mitigation step by transmitting an anomaly detection signal 230 to mitigator 142. Depending on the implementation, anomaly detection signal 230 comprises an indication of the potential anomaly, resources impacted by the potential anomaly, user accounts responsible for and/or otherwise impacted by the potential anomaly, secrets and/or sensitive data potentially exposed by the potential anomaly, a severity level indicating a degree of potential damage the potential anomaly could cause, an anomaly score indicating a degree to which the potential anomaly is anomalous (e.g., with respect to regular activity of the tenant account, its resources, and/or user accounts), and/or any other information associated with the potential anomaly. In some embodiments, mitigator 142 generates a report 232 based on anomaly detection signal 230 and transmits report 232 indicating the potential anomaly to a device of an administrator (e.g., a device of a user of tenant admin computing device 104, a device of a user of security admin computing device 106, and/or a device of another admin user of system 100). In accordance with an embodiment, report 232 indicates a visualization of the potential anomaly (e.g., a visualization of security graph 120 or a portion thereof that shows the potential anomaly). In accordance with an embodiment, report 232 includes a video or image sequence (e.g., a graphics interchange format (GIF) file) showing changes in security graph 120 or a portion thereof over time.

In some embodiments, mitigator 142 generates an indication of the potential anomaly (e.g., report 232 or another type of notification), as described with respect to FIG. 2. However, embodiments described herein are not so limited. For instance, in some embodiments, mitigator 142 performs one or more automatic operations responsive to or otherwise based on anomaly detection signal 230. For instance, in accordance with an embodiment, mitigator 142 lowers an access level of a user account and/or resource that change evaluator 204 has determined is potentially compromised. In accordance with another embodiment, mitigator 142 causes a potentially compromised user account to be prompted to answer a security question or perform a multi-factor authentication process (e.g., provide an authentication token from an identity application, provide a code transmitted to a cellular device of a known authorized user, and/or the like). In accordance with another embodiment, mitigator 142 isolates a secret or sensitive data and/or a storage of the secret or sensitive data from a resource and/or user account identified as potentially anomalous. By automatically implementing mitigation steps, mitigator 142 is able to prevent potential attacks without relying on user (e.g., admin) intervention. In some embodiments, mitigator 142 performs an automatic mitigation step if a severity level of the potential anomaly satisfies a severity condition (e.g., if a severity score of the potential anomaly is above a threshold). By utilizing severity conditions, such embodiments decrease the likelihood of an automatic mitigation step impacting routine operations of the tenant and its users. Additional details regarding severity levels are described with respect to FIG. 7, as well as elsewhere herein.

Security graphs, such as security graph 120 of FIG. 1, are representations of a tenant account, its associated resources, and accounts of users associated with the tenant. Security graphs, and snapshots of security graphs, can be represented in various ways. For example, FIGS. 4A-4C show examples of snapshots 400A, 400B, and 400C of a security graph at different respective timestamps, in accordance with an example embodiment. In accordance with an embodiment, snapshots 400A-400C are generated by security graph generator 138 on behalf of a Tenant T (e.g., a tenant account of system 100 of FIG. 1, e.g., associated with tenant admin computing device 104). In an embodiment, snapshot 400A is a further example of snapshot 212, snapshot 400B is a further example of snapshot 216, and snapshot 400C is a further example of snapshot 222, as described with respect to FIG. 2. Snapshots 400A-400C illustrate a subset of resources and/or accounts associated with Tenant T, however, it is contemplated herein that Tenant T may have many more resources and/or accounts associated therewith (e.g., tens, hundreds, thousands, or even greater number of users, resources, and/or the like).

Snapshot 400A of FIG. 4A illustrates resources of Tenant T and their relationships with one another at a first timestamp, t₁. For instance, as shown in FIG. 4A, snapshot 400A shows a node 402 representative of a Virtual Machine 1, a node 404 representative of a Storage A, a node 406 representative of a Storage B, and a node 408 representative of a Storage C. In accordance with an embodiment, Virtual Machine 1 is a further example of virtual machine 128, virtual machine 130, or virtual machine 132, as described with respect to FIG. 1. In accordance with an embodiment, Storage A, Storage B, and Storage C are further examples of storage devices 126A-126n and/or respective portions of storage devices 126A-126n (e.g., disks, partitions, memory devices, and/or the like). In embodiments nodes 402-408 comprise additional information about properties of the resource they represent. For example, node 402 indicates additional properties of Virtual Machine 1 (e.g., a type of, an operating system of, applications executed by, access level of, a creation date of, an expiration date of, and/or any other information related to Virtual Machine 1). In an example, nodes 404-408 indicate additional properties of respective storages (e.g., data stored by, an authoring account of data stored by, a type of data stored by, a password protection of data stored by, a restricted access level of, and/or any other property of a respective storage).

As also shown in FIG. 4A, snapshot 400A comprises an edge 410 connecting nodes 402 and 406. In this context, edge 410 illustrates a relationship between nodes 402 and 406. For instance, in an example, edge 410 represents that Virtual Machine 1 has access to Storage B. Depending on the implementation, edge 410 indicates other information about the relationship between the nodes. For instance, in an example, edge 410 indicates whether Virtual Machine 1 has read-only, write-only, or read and write access to Storage B.

As described herein, security graph generator 138 generates snapshots on a periodic basis or responsive to changes in a tenant account and/or its associated resources and/or accounts. For example, suppose security graph generator 138 generates snapshot 400B of FIG. 4B at a timestamp t₂ different from t₂. Depending on the implementation security graph generator 138 automatically generates snapshot 400B (e.g., at a periodic interval) or generates snapshot 400B responsive to an update to the account of Tenant T and/or its resources, and/or activity of Tenant T, its associated resources, and/or its associated accounts. As shown in FIG. 4B, snapshot 400B includes nodes 402-408 and edge 410, as described with respect to FIG. 4A. Snapshot 400B also includes a node 412 representative of a User Account Bob. User Account Bob is an account of a user associated with Tenant T, e.g., a user account of the user of user computing device 102 of FIG. 1. In an implementation, User Account Bob is an account of a legitimate user of Tenant 1 (e.g., an employee, an owner, and/or the like). Alternatively, User Account Bob is an account created by and/or compromised by a malicious entity. In embodiments, node 412 indicates properties of User Account Bob (e.g., an access level thereof, a creation date thereof, an identity of an associated user, contact information of the associated user, an associated admin user that create the account, a manager of the associated user, and/or the like).

As also shown in FIG. 4B, snapshot 400B comprises an edge 414 connecting nodes 412 and 412. In this context, edge 414 illustrates a relationship between nodes 412 and 402. For instance, in an example, edge 414 represents that User Account has access to Virtual Machine 1. In accordance with an embodiment, edge 414 indicates a type of access User Account has to Virtual Machine 1 (e.g., administrative access, usage access, limited usage access, read only access, transmit/write only access, and/or the like). In accordance with an embodiment, edge 414 indicates activity User Account Bob has performed with respect to Virtual Machine 1 (e.g., commands transmitted to Virtual Machine 1, responses received therefrom, and/or the like).

Snapshot 400C of FIG. 4C illustrates a further update to the security graph at a timestamp t₃ different from t₁ and t₂. In snapshot 400C, an edge 416 is connecting nodes 402 and 404 and an edge 418 is connecting nodes 402 and 408. In this context, the addition of edges 416 and 418 indicates an expansion of Virtual Machine 1’s access to Storage A and Storage C. In embodiments, edge 416 indicates a type of access Virtual Machine 1 has to Storage A and edge 418 indicates a type of access Virtual Machine 1 has to Storage B.

In embodiments, change detector 202 of FIG. 2 receives snapshots 400A-400C and determines if there are changes in a security graph based on snapshots 400A-400C, e.g., as described with respect to steps 306 and 308 of flowchart 300 of FIG. 3. Furthermore, change evaluator 204 is configured to evaluate the determined changes and detect potential anomalies based on the changes. By considering changes in security graphs and different (e.g., prior, subsequent, simultaneous, and/or the like) changes that are related to the first change(s), embodiments described herein increase the accuracy in detecting anomalous activity. For instance, as a non-limiting example, generation of User Account Bob and granting User Account Bob access to Virtual Machine 1 may not be anomalous on its own. However, the subsequent expansion of Virtual Machine 1’s access to additional storages (e.g., Storage A and Storage B) could, in some embodiments, indicate a potential attack where a user of User Account Bob is attempting to utilize Virtual Machine 1 to access data and expand the access rights of Virtual Machine 1. In a reverse analysis non-limiting example, the expansion of Virtual Machine 1’s access at a first timestamp is not anomalous on its own (in this example), but analysis of a change at a prior timestamp granting User Account Bob access to Virtual Machine 1 could indicate a potential attack.

Node 412 and edge 414 are illustrated with dotted lines in FIG. 4B to emphasize changes between snapshots 400A and 400B and edges 416 and 418 are illustrated with dotted lines in FIG. 4C to emphasize changes between snapshots 400B and 400C. In some alternative embodiments, snapshot graph generator 138 generates snapshots without explicit indications of changes between the snapshot and a previously generated snapshot. In this scenario, change detector 202 determines the change (or changes, if any) between snapshots (e.g., by comparing visual representations (e.g., utilizing an image comparison), by comparing a list of properties of nodes, by comparing a list of nodes and edges, based on similarities of embeddings in vector space, and/or by another technique utilized for determining changes between snapshots, as described elsewhere herein). In an embodiment, if change detector 202 determines there is no change between the snapshots, change detector 202 causes only one of the snapshots to be stored in storage 112 as a snapshot 122 (or removes the duplicate snapshot from snapshots 122), thereby reducing the memory consumed by snapshots 122. In some embodiments, change detector 202 modifies a snapshot to indicate changes between that snapshot and a (e.g., immediately) preceding snapshot. For instance, in accordance with an embodiment, change detector 202 highlights, changes a line style, or otherwise indicates new nodes added to the graph and/or new edges between nodes in the graph. In this context, change detector 202 stores the modified snapshot (e.g., in storage 112) for later reference.

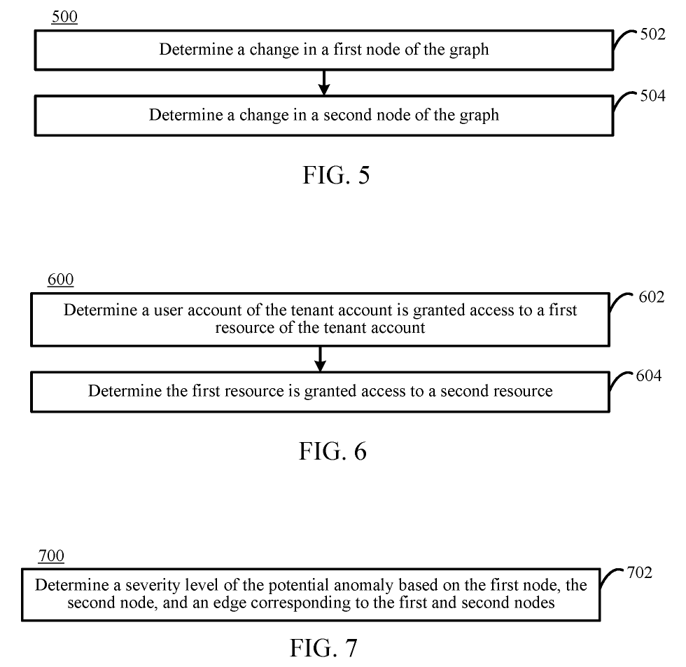

Embodiments of change detector 202 of FIG. 2 operate in various ways to determine changes in a security graph. For example, FIG. 5 shows a flowchart 500 of a process for determining changes in a security graph, in accordance with an example embodiment. In an embodiment, change detector 202 operates according to the steps of flowchart 500. Note that not all steps of flowchart 500 need be performed in all embodiments. Further structural and operational embodiments will be apparent to persons skilled in the relevant art(s) based on the following description of FIG. 5 with respect to FIGS. 2 and 4A-4C.

Flowchart 500 begins with step 502. Step 502 is a further example of step 306 of flowchart 300 of FIG. 3, in an embodiment. In step 502, a change in a first node of the graph is determined. For example, suppose change detector 202 of FIG. 2 receives snapshot 400A of FIG. 4A and snapshot 400B of FIG. 4B. In this context, change detector 202 detects the addition of node 412 and edge 414 in snapshot 400B. Change detector 202 detects the change in a similar manner as described with respect to step 306 of flowchart 300 of FIG. 3. For instance, in accordance with an embodiment, change detector 202 performs a visual comparison between snapshots 400B and 400A to identify the addition of node 412 and edge 414. In an alternative embodiment, change detector 202 compares embeddings of snapshot 400A and 400B to detect the addition of node 412 and edge 414. In another embodiment, change detector 202 compares a list of (or a table of) edges and/or nodes to detect the addition of node 412 and edge 414.

Flowchart 500 continues with step 504, which is a further example of step 308 of flowchart 300 of FIG. 3, in an embodiment. In step 504, a change in a second node of the graph is determined. For instance, suppose change detector 202 of FIG. 2 receives snapshot 400B of FIG. 4B and snapshot 400C of FIG. 4C. In this context, change detector 202 detects a change in node 402 based on the addition of edge 416 and/or edge 418 in snapshot 400C. In embodiments, change detector 202 detects the change in node 402 in a similar manner as described with respect to step 308 of flowchart 300 of FIG. 3.

As mentioned above, embodiments of change detector 202 of FIG. 2 operate in various ways to determine changes in a security graph. In some instances, change detector 202 detects changes in relationships between nodes of the security graph (e.g., edges of the security graph). In this context, change detector 202 of FIG. 2 operates in various ways to determine changes in the relationships. For instance, FIG. 6 shows a flowchart 600 of a process for determining changes in a security graph, in accordance with an example embodiment. In an embodiment, change detector 202 operates according to the steps of flowchart 600. Note that not all steps of flowchart 600 need be performed in all embodiments. Further structural and operational embodiments will be apparent to persons skilled in the relevant art(s) based on the following description of FIG. 6 with respect to FIGS. 2 and 4A-4C.

Flowchart 600 begins with step 602. Step 602 is a further example of step 306 of flowchart 300 of FIG. 3 and/or step 502 of flowchart 500 of FIG. 5, in an embodiment. In step 602, a user account of the tenant account is determined to be granted access to a first resource of the tenant account. For example, suppose change detector 202 of FIG. 2 receives snapshot 400A of FIG. 4A and snapshot 400B of FIG. 4B. In this context, change detector 202 detects that User Account represented by node 412 is granted access to Virtual Machine 1 represented by node 402 (e.g., based on the addition of edge 414 in snapshot 400B). Change detector 202 detects the change in a similar manner as described with respect to step 306 of flowchart 300 of FIG. 3 and/or step 502 of flowchart 500 of FIG. 5.

Flowchart 600 continues with step 604, which is a further example of step 308 of flowchart 300 of FIG. 3 and/or step 504 of flowchart 500 of FIG. 5, in an embodiment. In step 604, the first resource is determined to be granted access to a second resource. For instance, suppose change detector 202 of FIG. 2 receives snapshot 400B of FIG. 4B and snapshot 400C of FIG. 4C. In this context, change detector 202 determines Virtual Machine 1, represented by node 402, is granted access to Storage A and Storage B, respectively represented by nodes 404 and 408, based on the addition of edges 416 and 418. Change detector 202 detects the change in a similar manner as described with respect to step 308 of flowchart 300 of FIG. 3 and/or step 504 of flowchart 500 of FIG. 5.

In some embodiments, change evaluator 204 of FIG. 2 determines a severity level of a detected potential anomaly. In this context, mitigator 142 and/or an admin user is able to prioritize addressing the potential anomaly based on the severity level. Furthermore, in some embodiments, mitigator 142 performs an automatic mitigation step based on the severity level. As described herein, the severity level is indicative of the degree to which the potential anomaly poses a potential threat to the tenant account. Change evaluator 204 of FIG. 2 operates in various ways to determine a severity level of a potential anomaly, in embodiments. For example, FIG. 7 shows a flowchart 700 of a process for determining a severity level of a potential anomaly, in accordance with an example embodiment. In an embodiment, change evaluator 204 operates according to flowchart 700. Note that flowchart 700 need not be performed in all embodiments. Further structural and operational embodiments will be apparent to persons skilled in the relevant art(s) based on the following description of FIG. 7 with respect to FIGS. 2 and 4A-4C.

Flowchart 700 comprises step 702. In step 702, a severity level of the potential anomaly is determined based on the first node, the second node, and an edge corresponding to the first and second nodes. For example, change evaluator 204 determines a severity level of the potential anomaly indicated by anomaly detection signal 230 based on node 402, node 412, and edge 414 of FIG. 4B. Depending on the implementation, change evaluator 204 evaluates various features of nodes and/or edges to determine the severity level. For instance, suppose User Account of node 412 is a newly created account and edge 414 is an admin-level relationship between User Account and Virtual Machine 1 of node 402. In this context, change evaluator 204 determines a severity level of a first value that indicates a new user being granted admin level access to an existing relationship is anomalous. Further suppose Virtual Machine 1 is a confidential virtual machine with access to sensitive information and/or secrets (e.g., stored in Storage B of node 406). In this context, change evaluator 204 determines a severity level of a higher value than if Virtual Machine 1 was a regular virtual machine. In some embodiments, change evaluator 204 indicates the severity level of the potential anomaly in anomaly detection signal 230. In some embodiments, change evaluator 204 assigns a severity level as a tag indicating a degree of severity (e.g., “low severity”, “moderate severity”, “high severity”, and/or the like). In some embodiments, change evaluator 204 calculates a score (e.g., a percentage, a numerical value on a scale (e.g., 1 to 100, 0 to 1, 1 to 10, and/or the like), and/or the like) indicating the degree of severity.

In some embodiments, change evaluator 204 changes a severity level based on successive detected changes. For instance, in accordance with an embodiment, suppose change evaluator 204 assigned the potential anomaly a first severity level subsequent to evaluating the changes between snapshots 400A and 400B of FIGS. 4A and 4B. Further suppose change evaluator 204 determines the severity of the potential anomaly is more severe based on a subsequent snapshot (and/or analysis of other additional snapshots, e.g., prior snapshots). For instance, change evaluator 204 receives snapshot 400C of FIG. 4C and determines the potential anomaly is more likely to indicate a potential attack (e.g., as Virtual Machine 1 has access to more storage devices). In some embodiments, change evaluator 204 does not cause mitigator 142 to perform a mitigation step until the severity level of the potential anomaly satisfies a severity criterion (e.g., the potential anomaly reaches a particular severity level). By causing mitigation steps based on the severity level satisfying a severity criterion, such embodiments reduce flagging regular activity as a potential anomalous activity (e.g., a false flag).

In some examples, a user account is provided access to multiple resources (e.g., directly or through additional connections). In this context, security system 110 generates a security graphs representative of these changes. For example, FIG. 8 shows an example snapshot 800 of a security graph at a timestamp, in accordance with an example embodiment. In accordance with an embodiment, snapshot 800 is a snapshot generated by security graph generator 138 on behalf of Tenant T subsequent to snapshot 400C of FIG. 4C, e.g., at a timestamp t₄ subsequent to t₃. Snapshot 800 illustrates a subset of resources and/or accounts associated with Tenant T; however, it is contemplated herein that Tenant T may have many more resources and/or accounts associated therewith.

Snapshot 800 of FIG. 8 illustrates resources of Tenant T and their relationships with one another. For instance, as shown in FIG. 8, snapshot 800 comprises nodes 402-408, edge 410, node 412, and edges 414-418, as described with respect to FIGS. 4A-4C. As also shown in FIG. 8, snapshot 800 comprises nodes 802-808 and edges 812-818. Node 802 represents a Virtual Machine 2 of Tenant T, node 804 represents a Virtual Machine 3 of Tenant T, node 806 represents a Storage D of Tenant T, and node 806 represents a Storage E of Tenant T. In accordance with an embodiment, Virtual Machine 2 and Virtual Machine 3 are further examples of any of virtual machine 128, virtual machine 130, and virtual machine 132, as described with respect to FIG. 1. For instance, in a non-limiting example, Virtual Machine 1 is an example of virtual machine 128, Virtual Machine 2 is an example of virtual machine 130, and Virtual Machine 3 is an example of virtual machine 132. In accordance with an embodiment, Storage D and Storage E are further examples of storage devices 126A-126n and/or respective portions of storage devices 126A-126n. In accordance with an embodiment, two or more of Virtual Machine 1, Virtual Machine 2, Virtual Machine 3, Storage A, Storage B, Storage C, Storage D, and/or Storage E are implemented within a cluster. Alternatively, each of the virtual machines and storages of snapshot 800 are implemented in separate clusters or in an un-clustered computing environment.

As described above, snapshot 800 comprises edges 812-818. Edges 812-818 represent relationships between respective connected nodes. For example, edge 812 connects nodes 412 and 802, edge 814 connects nodes 802 and 806, edge 816 connects nodes 412 and 804, and edge 818 connects nodes 804 and 808. Edge 812 represents User Account having access to Virtual Machine 2, edge 814 represents Virtual Machine 2 having access to Storage D, edge 816 represents User Account Bob having access to Virtual Machine 3, and edge 818 represents Virtual Machine 3 having access to Storage E. Depending on the implementation, edges 812-818 indicate other information about the relationship between respective nodes, e.g., a type of access a node has to another node, activity between the nodes (e.g., data read from one node by another, a command transmitted from one node to the other, and/or the like), and/or other information related to the relationship between the nodes.

In embodiments, nodes of snapshot 800 include additional information about their respective resource and/or account. For instance, as shown in snapshot 800, node 412 comprises a privilege tag 810 indicating that User Account Bob is granted admin privilege with respect to resources of Tenant T. In an embodiment, the granted admin privileges provide User Account administrative control over resources accessible to User Account (e.g., Virtual Machine 1, Virtual Machine 2, and Virtual Machine 3) and/or resources accessible to those resources (e.g., Storages A-E). In an alternative embodiment, the granted admin privileges provide User Account Bob administrative control over other aspects of Tenant T’s account, e.g., privileges to generate other user accounts, to grant privileges to other user accounts, to obtain access to other resources, to generate resources, and/or the like.

Embodiments of anomaly detector 140 of FIGS. 1 and 2 operate in various ways to evaluate a sequence of changes, such as those shown in snapshot 800 of FIG. 8. For example, FIG. 9 shows a flowchart 900 of a process for detecting malicious activity based on changes in a security graph, in accordance with an example embodiment. In an embodiment, anomaly detector 140 operates according to the steps of flowchart 900. Note that not all steps of flowchart 900 need be performed in all embodiments. Further structural and operational embodiments will be apparent to persons skilled in the relevant art(s) based on the following description of FIG. 9 with respect to FIGS. 2 and 8.

Flowchart 900 begins with step 902, which is performed subsequent to step 308 of flowchart 300 of FIG. 3, in an example embodiment. In step 902, a plurality of changes in the graph are determined at different timestamps from the second change in the graph. For example, change detector 202 of FIG. 2 determines multiple changes in security graph 120 different from changes determined with respect to snapshot 400C of FIG. 4C. For instance, change detector 220 detects the addition of edges 812 and 816 connecting node 412 to nodes 802 and 804, respectively, the addition of edge 814 connecting nodes 802 and 806, the addition of edge 818 connecting nodes 804 and 808, and the granting of admin privilege 810 to User Account Bob. In some embodiments, nodes 802 and 804 are new nodes (e.g., indicative of new resources added to the tenant account). Alternatively, nodes 802 and 804 are existing nodes newly associated with node 412. In some embodiments, node 802 is connected to node 806 and/or node 804 is connected to node 808 prior to node 412 being connected to nodes 802 and/or 804. Alternatively, edges 814 and/or 818 are added to security graph 120 simultaneous to or subsequent to edges 812 and/or 816. Furthermore, while FIG. 8 illustrates the addition of nodes 802-808, edges 812-818, and admin privilege 810, it’s also contemplated herein that these nodes, edges, and/or feature are added to security graph 120 over a series of snapshots.

Flowchart 900 continues to steps 904 and 906, which are further examples of step 310 of flowchart 300 of FIG. 3, in an example embodiment. In step 904, a relationship between the first change in the graph, the second change in the graph, and the plurality of other changes in the graph is determined. For example, change evaluator 204 of FIG. 2 determines a relationship between the plurality of other changes determined in step 902. For instance, change evaluator 204 tracks relationships (e.g., edges) between changes in nodes of security graph 120 based on snapshot 800 and previous one or more snapshot(s) (e.g., snapshots 400A, 400B, and/or 400C) and/or subsequent one or more snapshot(s). In this manner, change evaluator 204 identifies changes in nodes and/or edges that are related to one another. For instance, change evaluator 204 is able to flag or otherwise determine that a change in node 412 is potentially related to a change in node 802, which is potentially related to a change in node 806.

In step 906, the relationship is determined to satisfy a cumulative anomaly criterion. For example, change evaluator 204 determines the relationship(s) identified in step 904 satisfy a cumulative anomaly criterion. If the relationship satisfies a cumulative anomaly criterion, change evaluator 204 determines the changes are indicative of a potential anomaly. By determining multiple changes in a security graph are related, change evaluator 204 is able to determine that (e.g., many) related changes (which may not individually indicate anomalous activity) indicate a potential anomaly. In accordance with an embodiment, change evaluator 204 determines the relationship satisfies a cumulative anomaly criterion if a number of changes reaches or exceeds a threshold. In accordance with another embodiment, change evaluator 204 determines the relationship satisfies a cumulative anomaly criterion if a cumulative severity of the changes reaches or exceeds a threshold. In accordance with another embodiment, change evaluator 204 determines the relationship satisfies a cumulative anomaly criterion if a number of changes within a particular period of time reaches or exceeds a threshold.

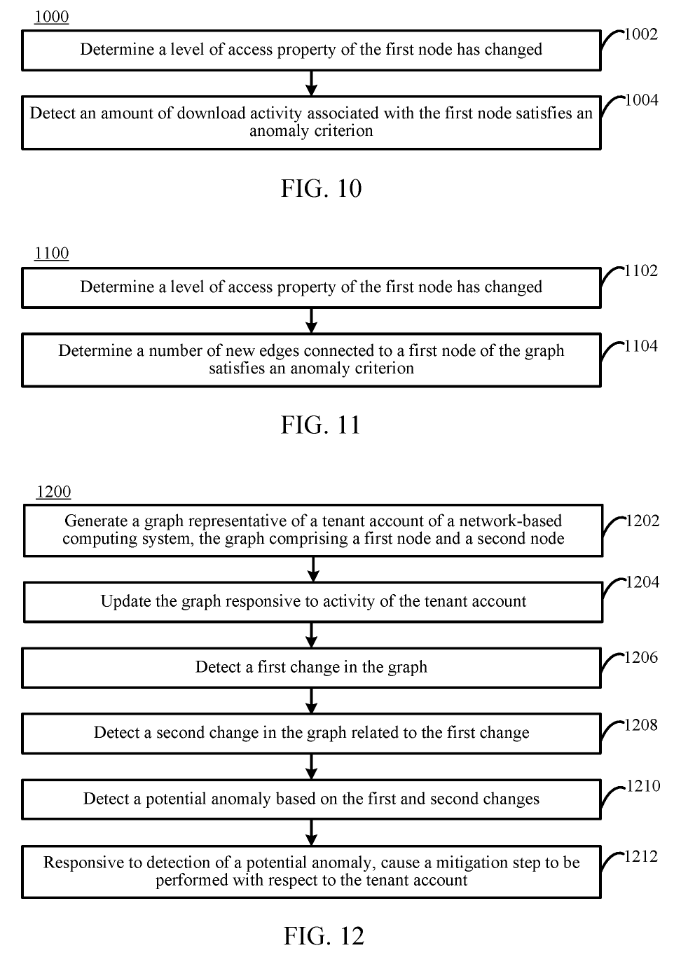

Anomaly detector 140 detects potential anomalies in various ways, in embodiments. For instance, anomaly detector 140 in accordance with an embodiment detects a potential anomaly based on activity of a node and changes in a graph. Anomaly detector 140 operates in various ways to detect anomalies based on activity and changes. For example, FIG. 10 shows a flowchart 1000 of a process for detecting malicious activity based on changes in a security graph, in accordance with an example embodiment. In an embodiment, anomaly detector 140 operates according to the steps of flowchart 1000. Note that not all steps of flowchart 1000 need be performed in all embodiments. Further structural and operational embodiments will be apparent to persons skilled in the relevant art(s) based on the following description of FIG. 10 with respect to FIGS. 2 and 8.

Flowchart 1000 begins with step 1002, which is a further example of step 306 of flowchart 300 of FIG. 3, in an embodiment. In step 1002, a level of access property of a first node is determined to have changed. For example, suppose change detector 202 of FIG. 2 receives snapshot 400C of FIG. 4C and snapshot 800 of FIG. 8. In this example, change detector 202 detects a change in the level of access of User Account Bob of node 412, i.e., from a “user privilege” level to an “admin privilege” level. In another example, change detector 202 detects a change in a type of access. For instance, suppose Virtual Machine 2 is able to write to Storage D but not read data stored in Storage D (or only able to read data written to Storage D by itself). Suppose, in this other example, change detector 202 detects a change in permissions Virtual Machine 2 has with respect to Storage D to include reading data or reading data other than that written by itself.

Flowchart 1000 continues to step 1004, which is a further example of steps 308 and/or 310 of flowchart 300 of FIG. 3, in an embodiment. In step 1002, an amount of download activity associated with the first node is detected as satisfying an anomaly criterion. For example, change evaluator 204 of FIG. 2 determines download activity associated with node 412 satisfies an anomaly criterion. In this context, the download activity indicates node 412 is receiving data at a higher rate than usual, is accessing data from more nodes than usual, or is accessing data from groups of nodes it does not typically access. In some embodiments, change evaluator 204 detects download activity through multiple levels of dependency. For instance, change evaluator 204 in an example detects that Virtual Machine 1 is downloading data from Storages A-D at a higher rate than usual based on two snapshots of security graph 120 (e.g., snapshot 800 and a subsequent snapshot, e.g., snapshot 800 and a prior snapshot, and/or the like). Change evaluator 204 further determines based on two subsequent snapshots or one of the snapshots and a subsequent snapshot that User Account Bob is receiving data from Virtual Machine 1 at a higher rate than usual or is otherwise accessing Virtual Machine 1 more often than usual. Change evaluator 204 determines this cumulative activity satisfies an anomaly criterion and that a potential anomaly is occurring with respect to User Account Bob.

As described elsewhere herein, in some embodiments, anomaly detector 140 detects a potential anomaly based on a change in a “blast radius” of a node. In some embodiments, the blast radius is determined by a range of other nodes that a first node has access to. Anomaly detector 140 operates in various ways to detect potential anomalies based on a blast radius. For example, FIG. 11 shows a flowchart 1100 of a process for detecting malicious activity based on changes in a security graph, in accordance with an example embodiment. In an embodiment, anomaly detector 140 operates according to the steps of flowchart 1100. Note that not all steps of flowchart 1100 need be performed in all embodiments. Further structural and operational embodiments will be apparent to persons skilled in the relevant art(s) based on the following description of FIG. 11 with respect to FIGS. 2, 4C, and 8.

Flowchart 1100 begins with step 1102, which is a further example of step 306 of flowchart 300 of FIG. 3, in an embodiment. In step 1102, a level of access property of the first node is determined to have changed. For example, suppose change detector 202 of FIG. 2 receives snapshots 400C of FIG. 4C and 800 of FIG. 8. In this context, change detector 202 detects a change in the level of access User Account Bob has, as described elsewhere herein, e.g., with respect to step 1002 of flowchart 1000 of FIG. 10.

Flowchart 1100 continues with step 1104, which is a further example of steps 308 and/or 310 of flowchart 300 of FIG. 3, in an embodiment. In step 1104, a number of new edges connected to a first node of the graph is determined to satisfy an anomaly criterion. For example, with continued reference to the example described with respect to step 1102, change detector 202 detects the addition of edges 812 and 816 in snapshot 800. Change evaluator 204 determines the addition of edges 812 and 816 (and/or edges 814 and 818) satisfies an anomaly criterion. While the example in FIG. 8 shows only two edges being added between node 412 and respective resource nodes, it is contemplated herein that an anomaly criterion can be set to require many edges to other nodes be generated (e.g., tens, hundreds, and/or the like). In some embodiments, the anomaly criterion specifies a number of edges added over a predetermined period of time. In some embodiments, the anomaly criterion weights edges connected to new nodes differently than existing nodes. For example, an edge connected to a node representative of a newly assigned resource (e.g., a secret of the user account that node 412 is representative of, a virtual machine assigned to the user account by a manager account, and/or the like) is weighted less anomalous than an edge connected to a node representative of an existing resource (e.g., a resource having access to a group secret, an existing confidential virtual machine, and/or the like). Furthermore, change evaluator 204 in accordance with an embodiment considers edges added to dependent nodes. For instance, the addition of edges 812 and 816 alone may not be considered anomalous in one implementation, however, in this implementation, change evaluator 204 determines the combined addition of edges 812 and 816 and 416 and 418 to indicate a potential anomaly.

Several example embodiments have been described with respect to anomaly detector 140 of FIGS. 1 and 2 where anomaly detector 140 receives snapshots of a graph as it changes over time or at predetermined intervals. In an alternative embodiment, anomaly detector 140 actively monitors a security graph as it is generated and/or updated by security graph generator 138. Anomaly detector 140 operates in various ways to actively monitor a security graph, in embodiments. For example, FIG. 12 shows a flowchart 1200 of a process for detecting malicious activity based on changes in a security graph, in accordance with an example embodiment. In an embodiment, security system 110 operates according to the steps of flowchart 1200. Note that not all steps of flowchart 1200 need be performed in all embodiments. Further structural and operational embodiments will be apparent to persons skilled in the relevant art(s) based on the following description of FIG. 12 with respect to FIG. 2.

Flowchart 1200 begins with step 1202. In step 1202, a graph representative of a tenant account of a network-based computing system is generated, the graph comprising a first node and a second node. For example, as described with respect to FIG. 2, in accordance with an embodiment, security graph generator 138 generates security graph 120. In accordance with an embodiment, security graph 120 comprises a plurality of nodes. As described herein, nodes represent resources and/or user accounts of a tenant account. In accordance with an embodiment, security graph generator 138 generates and maintains security graph 120 in working memory of security system 110. Alternatively, security graph 120 is stored as snapshots, as described elsewhere herein.

In step 1204, the graph is updated responsive to activity of the tenant account. For example, security graph generator 138 updates security graph 120 responsive to activity of the tenant account (e.g., Tenant T). For instance, as shown in FIG. 2, security graph generator 138 updates security graph 120 based on tenant data 214 and tenant data 220.

In step 1206, a first change in the graph is detected. For instance, change detector 202 detects a first change in security graph 120. In accordance with an embodiment, change detector 202 detects the first change based on a snapshot provided thereto, e.g., as described with respect to step 306 of flowchart 300 of FIG. 3. Alternatively, change detector 202 monitors security graph 120 and detects the first change.

In step 1208, a second change related to the first change is detected. For instance, change detector 202 detects a second change in security graph 120. In accordance with an embodiment, change detector 202 detects the second change based on a snapshot provided thereto, e.g., as described with respect to step 308 of flowchart 300 of FIG. 3. Alternatively, change detector 202 monitors security graph 120 and detects the second change. In accordance with an embodiment, change evaluator 204 determines the second change is related to the first change.

In step 1210, a potential anomaly is detected based on the first and second changes. For example, change evaluator 204 detects a potential anomaly based on the first and second changes detected in steps 1206 and 1210. In embodiments, change evaluator 204 detects the potential anomaly in a similar manner as described with respect to step 310 of flowchart 300 of FIG. 3, as well as elsewhere herein.

In step 1212, responsive to detection of a potential anomaly, a mitigation step is caused to be performed with respect to the tenant account. For example, change evaluator 204 causes mitigator 142 to perform a mitigation step with respect to the tenant account. In embodiments, change evaluator 204 causes performance of the mitigation step in a similar manner as described with respect to step 312 of flowchart 300 of FIG. 3, as well as elsewhere herein.

### Example Computer System Implementation

Embodiments of malicious activity detection described herein are implemented in hardware, or hardware combined with one or both of software and/or firmware. For example application 114, admin application 116, admin application 118, security graph 120, virtual machine 128, virtual machine 130, virtual machine 132, security graph generator 138, anomaly detector 140, mitigator 142, change detector 202, change evaluator 204, Virtual Machine 1, Virtual Machine 2, Virtual Machine 3, and/or the components described therein, and/or the steps of flowcharts 300, 500, 600, 700, 900, 1000, 1100, and/or 1200, are each implemented as computer program code/instructions configured to be executed in one or more processors and stored in a computer readable storage medium. Alternatively, user computing device 102, tenant admin computing device 104, security admin computing device 106, security system 110, storage 112, application 114, admin application 116, admin application 118, security graph 120, server 124A, server 124n, storage device 126A, storage device 126n, virtual machine 128, virtual machine 130, virtual machine 132, security graph generator 138, anomaly detector 140, mitigator 142, change detector 202, change evaluator 204, Virtual Machine 1, Storage A, Storage B, Storage C, Virtual Machine 2, Virtual Machine 3, Storage D, Storage E, and/or the components described therein, and/or the steps of flowcharts 300, 500, 600, 700, 900, 1000, 1100, and/or 1200, are implemented in one or more SoCs (system on chip). An SoC includes an integrated circuit chip that includes one or more of a processor (e.g., a central processing unit (CPU), microcontroller, microprocessor, digital signal processor (DSP), etc.), memory, one or more communication interfaces, and/or further circuits, and optionally executes received program code and/or include embedded firmware to perform functions.

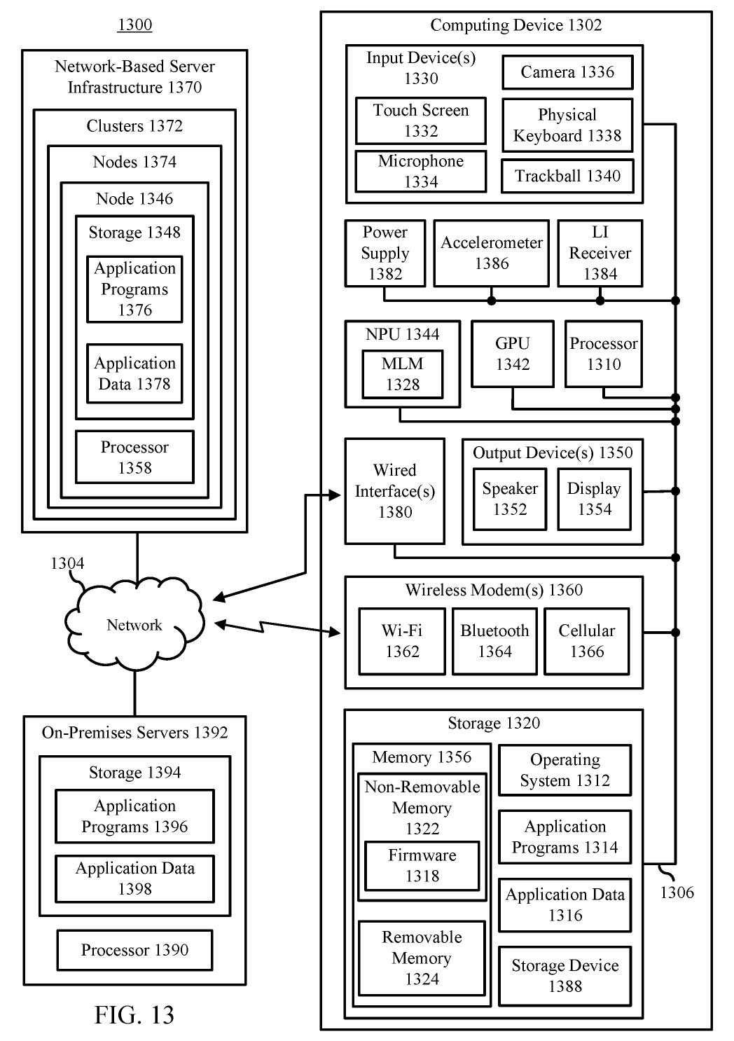

Embodiments disclosed herein can be implemented in one or more computing devices that are mobile (a mobile device) and/or stationary (a stationary device) and include any combination of the features of such mobile and stationary computing devices. Examples of computing devices in which embodiments are implementable are described as follows with respect to FIG. 13. FIG. 13 shows a block diagram of an exemplary computing environment 1300 that includes a computing device 1302. Computing device 1302 is an example of user computing device 102, tenant admin computing device 104, security admin computing device 106, security system 110, storage 112, server 124A, server 124n, storage device 126A, and/or storage device 126n, which each include one or more of the components of computing device 1302. In some embodiments, computing device 1302 is communicatively coupled with devices (not shown in FIG. 13) external to computing environment 1300 via network 1304. Network 1304 comprises one or more networks such as local area networks (LANs), wide area networks (WANs), enterprise networks, the Internet, etc. In examples, network 1304 includes one or more wired and/or wireless portions. In some examples, network 1304 additionally or alternatively includes a cellular network for cellular communications. Network 1304 is an example of network 144, in an embodiment. Computing device 1302 is described in detail as follows.

Computing device 1302 can be any of a variety of types of computing devices. Examples of computing device 1302 include a mobile computing device such as a handheld computer (e.g., a personal digital assistant (PDA)), a laptop computer, a tablet computer, a hybrid device, a notebook computer, a netbook, a mobile phone (e.g., a cell phone, a smart phone, etc.), a wearable computing device (e.g., a head-mounted augmented reality and/or virtual reality device including smart glasses), or other type of mobile computing device. In an alternative example, computing device 1302 is a stationary computing device such as a desktop computer, a personal computer (PC), a stationary server device, a minicomputer, a mainframe, a supercomputer, etc.

As shown in FIG. 13, computing device 1302 includes a variety of hardware and software components, including a processor 1310, a storage 1320, a graphics processing unit (GPU) 1342, a neural processing unit (NPU) 1344, one or more input devices 1330, one or more output devices 1350, one or more wireless modems 1360, one or more wired interfaces 1380, a power supply 1382, a location information (LI) receiver 1384, and an accelerometer 1386. Storage 1320 includes memory 1356, which includes non-removable memory 1322 and removable memory 1324, and a storage device 1388. Storage 1320 also stores an operating system 1312, application programs 1314, and application data 1316. Wireless modem(s) 1360 include a Wi-Fi modem 1362, a Bluetooth modem 1364, and a cellular modem 1366. Output device(s) 1350 includes a speaker 1352 and a display 1354. Input device(s) 1330 includes a touch screen 1332, a microphone 1334, a camera 1336, a physical keyboard 1338, and a trackball 1340. Not all components of computing device 1302 shown in FIG. 13 are present in all embodiments, additional components not shown may be present, and in a particular embodiment any combination of the components are present. In examples, components of computing device 1302 are mounted to a circuit card (e.g., a motherboard) of computing device 1302, integrated in a housing of computing device 1302, or otherwise included in computing device 1302. The components of computing device 1302 are described as follows.

In embodiments, a single processor 1310 (e.g., central processing unit (CPU), microcontroller, a microprocessor, signal processor, ASIC (application specific integrated circuit), and/or other physical hardware processor circuit) or multiple processors 1310 are present in computing device 1302 for performing such tasks as program execution, signal coding, data processing, input/output processing, power control, and/or other functions. In examples, processor 1310 is a single-core or multi-core processor, and each processor core is single-threaded or multithreaded (to provide multiple threads of execution concurrently). Processor 1310 is configured to execute program code stored in a computer readable medium, such as program code of operating system 1312 and application programs 1314 stored in storage 1320. The program code is structured to cause processor 1310 to perform operations, including the processes/methods disclosed herein. Operating system 1312 controls the allocation and usage of the components of computing device 1302 and provides support for one or more application programs 1314 (also referred to as “applications” or “apps”). In examples, application programs 1314 include common computing applications (e.g., e-mail applications, calendars, contact managers, web browsers, messaging applications), further computing applications (e.g., word processing applications, mapping applications, media player applications, productivity suite applications), one or more machine learning (ML) models, as well as applications related to the embodiments disclosed elsewhere herein. In examples, processor(s) 1310 includes one or more general processors (e.g., CPUs) configured with or coupled to one or more hardware accelerators, such as one or more NPUs 1344 and/or one or more GPUs 1342.

Any component in computing device 1302 can communicate with any other component according to function, although not all connections are shown for ease of illustration. For instance, as shown in FIG. 13, bus 1306 is a multiple signal line communication medium (e.g., conductive traces in silicon, metal traces along a motherboard, wires, etc.) present to communicatively couple processor 1310 to various other components of computing device 1302, although in other embodiments, an alternative bus, further buses, and/or one or more individual signal lines is/are present to communicatively couple components. Bus 1306 represents one or more of any of several types of bus structures, including a memory bus or memory controller, a peripheral bus, an accelerated graphics port, and a processor or local bus using any of a variety of bus architectures.

Storage 1320 is physical storage that includes one or both of memory 1356 and storage device 1388, which store operating system 1312, application programs 1314, and application data 1316 according to any distribution. Non-removable memory 1322 includes one or more of RAM (random access memory), ROM (read only memory), flash memory, a solid-state drive (SSD), a hard disk drive (e.g., a disk drive for reading from and writing to a hard disk), and/or other physical memory device type. In examples, non-removable memory 1322 includes main memory and is separate from or fabricated in a same integrated circuit as processor 1310. As shown in FIG. 13, non-removable memory 1322 stores firmware 1318 that is present to provide low-level control of hardware. Examples of firmware 1318 include BIOS (Basic Input/Output System, such as on personal computers) and boot firmware (e.g., on smart phones). In examples, removable memory 1324 is inserted into a receptacle of or is otherwise coupled to computing device 1302 and can be removed by a user from computing device 1302. Removable memory 1324 can include any suitable removable memory device type, including an SD (Secure Digital) card, a Subscriber Identity Module (SIM) card, which is well known in GSM (Global System for Mobile Communications) communication systems, and/or other removable physical memory device type. In examples, one or more of storage device 1388 are present that are internal and/or external to a housing of computing device 1302 and are or are not removable. Examples of storage device 1388 include a hard disk drive, a SSD, a thumb drive (e.g., a USB (Universal Serial Bus) flash drive), or other physical storage device.

One or more programs are stored in storage 1320. Such programs include operating system 1312, one or more application programs 1314, and other program modules and program data. Examples of such application programs include computer program logic (e.g., computer program code/instructions) for implementing application 114, admin application 116, admin application 118, security graph 120, virtual machine 128, virtual machine 130, virtual machine 132, security graph generator 138, anomaly detector 140, mitigator 142, change detector 202, change evaluator 204, Virtual Machine 1, Virtual Machine 2, Virtual Machine 3, and/or the components described therein, and/or the steps of flowcharts 300, 500, 600, 700, 900, 1000, 1100, and/or 1200.

Storage 1320 also stores data used and/or generated by operating system 1312 and application programs 1314 as application data 1316. Examples of application data 1316 include web pages, text, images, tables, sound files, video data, and other data. In examples, application data 1316 is sent to and/or received from one or more network servers or other devices via one or more wired or wireless networks. Storage 1320 can be used to store further data including a subscriber identifier, such as an International Mobile Subscriber Identity (IMSI), and an equipment identifier, such as an International Mobile Equipment Identifier (IMEI). Such identifiers can be transmitted to a network server to identify users and equipment.

In examples, a user enters commands and information into computing device 1302 through one or more input devices 1330 and receives information from computing device 1302 through one or more output devices 1350. Input device(s) 1330 includes one or more of touch screen 1332, microphone 1334, camera 1336, physical keyboard 1338 and/or trackball 1340 and output device(s) 1350 includes one or more of speaker 1352 and display 1354. Each of input device(s) 1330 and output device(s) 1350 are integral to computing device 1302 (e.g., built into a housing of computing device 1302) or are external to computing device 1302 (e.g., communicatively coupled wired or wirelessly to computing device 1302 via wired interface(s) 1380 and/or wireless modem(s) 1360). Further input devices 1330 (not shown) can include a Natural User Interface (NUI), a pointing device (computer mouse), a joystick, a video game controller, a scanner, a touch pad, a stylus pen, a voice recognition system to receive voice input, a gesture recognition system to receive gesture input, or the like. Other possible output devices (not shown) can include piezoelectric or other haptic output devices. Some devices can serve more than one input/output function. For instance, display 1354 displays information, as well as operating as touch screen 1332 by receiving user commands and/or other information (e.g., by touch, finger gestures, virtual keyboard, etc.) as a user interface. Any number of each type of input device(s) 1330 and output device(s) 1350 are present, including multiple microphones 1334, multiple cameras 1336, multiple speakers 1352, and/or multiple displays 1354.

In embodiments where GPU 1342 is present, GPU 1342 includes hardware (e.g., one or more integrated circuit chips that implement one or more of processing cores, multiprocessors, compute units, etc.) configured to accelerate computer graphics (two-dimensional (2D) and/or three-dimensional (3D)), perform image processing, and/or execute further parallel processing applications (e.g., training of neural networks, etc.). Examples of GPU 1342 perform calculations related to 3D computer graphics, include 2D acceleration and framebuffer capabilities, accelerate memory-intensive work of texture mapping and rendering polygons, accelerate geometric calculations such as the rotation and translation of vertices into different coordinate systems, support programmable shaders that manipulate vertices and textures, perform oversampling and interpolation techniques to reduce aliasing, and/or support very high-precision color spaces.

In examples, NPU 1344 (also referred to as an “artificial intelligence (AI) accelerator” or “deep learning processor (DLP)”) is a processor or processing unit configured to accelerate artificial intelligence and machine learning applications, such as execution of machine learning (ML) model (MLM) 1328. In an example, NPU 1344 is configured for a data-driven parallel computing and is highly efficient at processing massive multimedia data such as videos and images and processing data for neural networks. NPU 1344 is configured for efficient handling of AI-related tasks, such as speech recognition, background blurring in video calls, photo or video editing processes like object detection, etc.

In embodiments disclosed herein that implement ML models, NPU 1344 can be utilized to execute such ML models, of which MLM 1328 is an example. For instance, where applicable, MLM 1328 is a generative AI model that generates content that is complex, coherent, and/or original. For instance, a generative AI model can create sophisticated sentences, lists, ranges, tables of data, images, essays, and/or the like. An example of a generative AI model is a language model. A language model is a model that estimates the probability of a token or sequence of tokens occurring in a longer sequence of tokens. In this context, a “token” is an atomic unit that the model is training on and making predictions on. Examples of a token include, but are not limited to, a word, a character (e.g., an alphanumeric character, a blank space, a symbol, etc.), a sub-word (e.g., a root word, a prefix, or a suffix). In other types of models (e.g., image based models) a token may represent another kind of atomic unit (e.g., a subset of an image). Examples of language models applicable to embodiments herein include large language models (LLMs), text-to-image AI image generation systems, text-to-video AI generation systems, etc. A large language model (LLM) is a language model that has a high number of model parameters. In examples, an LLM has millions, billions, trillions, or even greater numbers of model parameters. Model parameters of an LLM are the weights and biases the model learns during training. Some implementations of LLMs are transformer-based LLMs (e.g., the family of generative pre-trained transformer (GPT) models). A transformer is a neural network architecture that relies on self-attention mechanisms to transform a sequence of input embeddings into a sequence of output embeddings (e.g., without relying on convolutions or recurrent neural networks).

In further examples, NPU 1344 is used to train MLM 1328. To train MLM 1328, training data is that includes input features (attributes) and their corresponding output labels/target values (e.g., for supervised learning) is collected. A training algorithm is a computational procedure that is used so that MLM 1328 learns from the training data. Parameters/weights are internal settings of MLM 1328 that are adjusted during training by the training algorithm to reduce a difference between predictions by MLM 1328 and actual outcomes (e.g., output labels). In some examples, MLM 1328 is set with initial values for the parameters/weights. A loss function measures a dissimilarity between predictions by MLM 1328 and the target values, and the parameters/weights of MLM 1328 are adjusted to minimize the loss function. The parameters/weights are iteratively adjusted by an optimization technique, such as gradient descent. In this manner, MLM 1328 is generated through training by NPU 1344 to be used to generate inferences based on received input feature sets for particular applications. MLM 1328 is generated as a computer program or other type of algorithm configured to generate an output (e.g., a classification, a prediction/inference) based on received input features, and is stored in the form of a file or other data structure.

In examples, such training of MLM 1328 by NPU 1344 is supervised or unsupervised. According to supervised learning, input objects (e.g., a vector of predictor variables) and a desired output value (e.g., a human-labeled supervisory signal) train MLM 1328. The training data is processed, building a function that maps new data on expected output values. Example algorithms usable by NPU 1344 to perform supervised training of MLM 1328 in particular implementations include support-vector machines, linear regression, logistic regression, Naïve Bayes, linear discriminant analysis, decision trees, K-nearest neighbor algorithm, neural networks, and similarity learning.

In an example of supervised learning where MLM 1328 is an LLM, MLM 1328 can be trained by exposing the LLM to (e.g., large amounts of) text (e.g., predetermined datasets, books, articles, text-based conversations, webpages, transcriptions, forum entries, and/or any other form of text and/or combinations thereof). In examples, training data is provided from a database, from the Internet, from a system, and/or the like. Furthermore, an LLM can be fine-tuned using Reinforcement Learning with Human Feedback (RLHF), where the LLM is provided the same input twice and provides two different outputs and a user ranks which output is preferred. In this context, the user’s ranking is utilized to improve the model. Further still, in example embodiments, an LLM is trained to perform in various styles, e.g., as a completion model (a model that is provided a few words or tokens and generates words or tokens to follow the input), as a conversation model (a model that provides an answer or other type of response to a conversation-style prompt), as a combination of a completion and conversation model, or as another type of LLM model.

According to unsupervised learning, MLM 1328 is trained to learn patterns from unlabeled data. For instance, in embodiments where MLM 1328 implements unsupervised learning techniques, MLM 1328 identifies one or more classifications or clusters to which an input belongs. During a training phase of MLM 1328 according to unsupervised learning, MLM 1328 tries to mimic the provided training data and uses the error in its mimicked output to correct itself (i.e., correct weights and biases). In further examples, NPU 1344 perform unsupervised training of MLM 1328 according to one or more alternative techniques, such as Hopfield learning rule, Boltzmann learning rule, Contrastive Divergence, Wake Sleep, Variational Inference, Maximum Likelihood, Maximum A Posteriori, Gibbs Sampling, and backpropagating reconstruction errors or hidden state reparameterizations.

Note that NPU 1344 need not necessarily be present in all ML model embodiments. In embodiments where ML models are present, any one or more of processor 1310, GPU 1342, and/or NPU 1344 can be present to train and/or execute MLM 1328.

One or more wireless modems 1360 can be coupled to antenna(s) (not shown) of computing device 1302 and can support two-way communications between processor 1310 and devices external to computing device 1302 through network 1304, as would be understood to persons skilled in the relevant art(s). Wireless modem 1360 is shown generically and can include a cellular modem 1366 for communicating with one or more cellular networks, such as a GSM network for data and voice communications within a single cellular network, between cellular networks, or between the mobile device and a public switched telephone network (PSTN). In examples, wireless modem 1360 also or alternatively includes other radio-based modem types, such as a Bluetooth modem 1364 (also referred to as a “Bluetooth device”) and/or Wi-Fi modem 1362 (also referred to as an “wireless adaptor”). Wi-Fi modem 1362 is configured to communicate with an access point or other remote Wi-Fi-capable device according to one or more of the wireless network protocols based on the IEEE (Institute of Electrical and Electronics Engineers) 802.11 family of standards, commonly used for local area networking of devices and Internet access. Bluetooth modem 1364 is configured to communicate with another Bluetooth-capable device according to the Bluetooth short-range wireless technology standard(s) such as IEEE 802.15.1 and/or managed by the Bluetooth Special Interest Group (SIG).

Computing device 1302 can further include power supply 1382, LI receiver 1384, accelerometer 1386, and/or one or more wired interfaces 1380. Example wired interfaces 1380 include a USB port, IEEE 1394 (FireWire) port, a RS-232 port, an HDMI (High-Definition Multimedia Interface) port (e.g., for connection to an external display), a DisplayPort port (e.g., for connection to an external display), an audio port, and/or an Ethernet port, the purposes and functions of each of which are well known to persons skilled in the relevant art(s). Wired interface(s) 1380 of computing device 1302 provide for wired connections between computing device 1302 and network 1304, or between computing device 1302 and one or more devices/peripherals when such devices/peripherals are external to computing device 1302 (e.g., a pointing device, display 1354, speaker 1352, camera 1336, physical keyboard 1338, etc.). Power supply 1382 is configured to supply power to each of the components of computing device 1302 and receives power from a battery internal to computing device 1302, and/or from a power cord plugged into a power port of computing device 1302 (e.g., a USB port, an A/C power port). LI receiver 1384 is useable for location determination of computing device 1302 and in examples includes a satellite navigation receiver such as a Global Positioning System (GPS) receiver and/or includes other type of location determiner configured to determine location of computing device 1302 based on received information (e.g., using cell tower triangulation, etc.). Accelerometer 1386, when present, is configured to determine an orientation of computing device 1302.

Note that the illustrated components of computing device 1302 are not required or all-inclusive, and fewer or greater numbers of components can be present as would be recognized by one skilled in the art. In examples, computing device 1302 includes one or more of a gyroscope, barometer, proximity sensor, ambient light sensor, digital compass, etc. In an example, processor 1310 and memory 1356 are co-located in a same semiconductor device package, such as being included together in an integrated circuit chip, FPGA, or system-on-chip (SOC), optionally along with further components of computing device 1302.

In embodiments, computing device 1302 is configured to implement any of the above-described features of flowcharts herein. Computer program logic for performing any of the operations, steps, and/or functions described herein is stored in storage 1320 and executed by processor 1310.

In some embodiments, server infrastructure 1370 is present in computing environment 1300 and is communicatively coupled with computing device 1302 via network 1304. Server infrastructure 1370, when present, is a network-accessible server set (e.g., a cloud-based environment or platform). As shown in FIG. 13, server infrastructure 1370 includes clusters 1372. Each of clusters 1372 comprises a group of one or more compute nodes and/or a group of one or more storage nodes. For example, as shown in FIG. 13, cluster 1372 includes nodes 1374. Each of nodes 1374 are accessible via network 1304 (e.g., in a “cloud-based” embodiment) to build, deploy, and manage applications and services. In examples, any of nodes 1374 is a storage node that comprises a plurality of physical storage disks, SSDs, and/or other physical storage devices that are accessible via network 1304 and are configured to store data associated with the applications and services managed by nodes 1374.

Each of nodes 1374, as a compute node, comprises one or more server computers, server systems, and/or computing devices. For instance, a node 1374 in accordance with an embodiment includes one or more of the components of computing device 1302 disclosed herein. Each of nodes 1374 is configured to execute one or more software applications (or “applications”) and/or services and/or manage hardware resources (e.g., processors, memory, etc.), which are utilized by users (e.g., customers) of the network-accessible server set. In examples, as shown in FIG. 13, nodes 1374 includes a node 1346 that includes storage 1348 and/or one or more of a processor 1358 (e.g., similar to processor 1310, GPU 1342, and/or NPU 1344 of computing device 1302). Storage 1348 stores application programs 1376 and application data 1378. Processor(s) 1358 operate application programs 1376 which access and/or generate related application data 1378. In an implementation, nodes such as node 1346 of nodes 1374 operate or comprise one or more virtual machines, with each virtual machine emulating a system architecture (e.g., an operating system), in an isolated manner, upon which applications such as application programs 1376 are executed.

In embodiments, one or more of clusters 1372 are located/co-located (e.g., housed in one or more nearby buildings with associated components such as backup power supplies, redundant data communications, environmental controls, etc.) to form a datacenter, or are arranged in other manners. Accordingly, in an embodiment, one or more of clusters 1372 are included in a datacenter in a distributed collection of datacenters. In embodiments, exemplary computing environment 1300 comprises part of a cloud-based platform.

In an embodiment, computing device 1302 accesses application programs 1376 for execution in any manner, such as by a client application and/or a browser at computing device 1302.

In an example, for purposes of network (e.g., cloud) backup and data security, computing device 1302 additionally and/or alternatively synchronizes copies of application programs 1314 and/or application data 1316 to be stored at network-based server infrastructure 1370 as application programs 1376 and/or application data 1378. In examples, operating system 1312 and/or application programs 1314 include a file hosting service client configured to synchronize applications and/or data stored in storage 1320 at network-based server infrastructure 1370.

In some embodiments, on-premises servers 1392 are present in computing environment 1300 and are communicatively coupled with computing device 1302 via network 1304. On-premises servers 1392, when present, are hosted within an organization’s infrastructure and, in many cases, physically onsite of a facility of that organization. On-premises servers 1392 are controlled, administered, and maintained by IT (Information Technology) personnel of the organization or an IT partner to the organization. Application data 1398 can be shared by on-premises servers 1392 between computing devices of the organization, including computing device 1302 (when part of an organization) through a local network of the organization, and/or through further networks accessible to the organization (including the Internet). Furthermore, in examples, on-premises servers 1392 serve applications such as application programs 1396 to the computing devices of the organization, including computing device 1302. Accordingly, in examples, on-premises servers 1392 include storage 1394 (which includes one or more physical storage devices such as storage disks and/or SSDs) for storage of application programs 1396 and application data 1398 and include a processor 1390 (e.g., similar to processor 1310, GPU 1342, and/or NPU 1344 of computing device 1302) for execution of application programs 1396. In some embodiments, multiple processors 1390 are present for execution of application programs 1396 and/or for other purposes. In further examples, computing device 1302 is configured to synchronize copies of application programs 1314 and/or application data 1316 for backup storage at on-premises servers 1392 as application programs 1396 and/or application data 1398.

Embodiments described herein may be implemented in one or more of computing device 1302, network-based server infrastructure 1370, and on-premises servers 1392. For example, in some embodiments, computing device 1302 is used to implement systems, clients, or devices, or components/subcomponents thereof, disclosed elsewhere herein. In other embodiments, a combination of computing device 1302, network-based server infrastructure 1370, and/or on-premises servers 1392 is used to implement the systems, clients, or devices, or components/subcomponents thereof, disclosed elsewhere herein.

As used herein, the terms “computer program medium,” “computer-readable medium,” “computer-readable storage medium,” and “computer-readable storage device,” etc., are used to refer to physical hardware media. Examples of such physical hardware media include any hard disk, optical disk, SSD, other physical hardware media such as RAMs, ROMs, flash memory, digital video disks, zip disks, MEMs (microelectronic machine) memory, nanotechnology-based storage devices, and further types of physical/tangible hardware storage media of storage 1320. Such computer-readable media and/or storage media are distinguished from and non-overlapping with communication media, propagating signals, and signals per se. Stated differently, “computer program medium,” “computer-readable medium,” “computer-readable storage medium,” and “computer-readable storage device” do not encompass communication media, propagating signals, and signals per se. Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared, and other wireless media, as well as wired media. Embodiments are also directed to such communication media that are separate and non-overlapping with embodiments directed to computer-readable storage media.

As noted above, computer programs and modules (including application programs 1314) are stored in storage 1320. Such computer programs can also be received via wired interface(s) 1360 and/or wireless modem(s) 1360 over network 1304. Such computer programs, when executed or loaded by an application, enable computing device 1302 to implement features of embodiments discussed herein. Accordingly, such computer programs represent controllers of the computing device 1302.

Embodiments are also directed to computer program products comprising computer code or instructions stored on any computer-readable medium or computer-readable storage medium. Such computer program products include the physical storage of storage 1320 as well as further physical storage types.

### Additional Example Embodiments

A system is described herein. The system comprises a processor and memory. The memory comprises program code structured to cause the processor to: receive a first snapshot of a graph representative of a tenant account of the network-based computing system, the first snapshot corresponding to a first timestamp; receive a second snapshot of the graph corresponding to a second timestamp different from the first timestamp; determine, based on the first and second snapshots, a first change in the graph; determine a second change in the graph related to the first change; detect a potential anomaly based on the first and second changes; and responsive to said detection of the potential anomaly, cause a mitigation step to be performed with respect to the tenant account.

In a further example of the foregoing system, the system is a security system of a network-based computing system.

In a further example of the foregoing system, the graph comprises a first node and a second node. The processor is caused to determine a first change in the graph by determining a change in the first node. The processor is caused to determine a second change in the graph by determining a change in the second node.

In a further example of the foregoing system, the first node represents a user account of the tenant account and the second node represents a first resource of the tenant account. The processor is caused to determine a change in the first node by determining the user account is granted access to the first resource.

In a further example of the foregoing system, the processor is caused to determine a change in the second node by determining the first resource is granted access to a second resource.

In a further example of the foregoing system, the processor is caused to detect a potential anomaly by determining a severity level of the potential anomaly based on the first node, the second node, and an edge corresponding to the first and second nodes.

In a further example of the foregoing system, the processor is caused to detect the potential anomaly by: determining a plurality of other changes in the graph different from the first and second changes in the graph; determining a relationship between the first change in the graph, the second change in the graph, and the plurality of other changes; and determining the relationship satisfies a cumulative anomaly criterion.

In a further example of the foregoing system, the processor is caused to determine a first change in the graph by determining a level of access property of a user account associated with the tenant account has changed. The processor is further caused to determine a number of new edges connected to a first node of the graph satisfies an anomaly criterion.

In a further example of the foregoing system, the processor is caused to determine a first change in the graph by determining a level of access property of a user account associated with the tenant account has changed. The processor is further caused to detect an amount of download activity associated with the user account satisfies an anomaly criterion.

In a further example of the foregoing system, the processor is further caused to receive a third snapshot of the graph corresponding to a third timestamp different from the first timestamp and the second timestamp. The processor is caused to determine the second change in the graph is based on the third snapshot.

A method is described herein. The method is for mitigating anomalies in a network-based computing system. The method comprises: receiving a first snapshot of a graph representative of a tenant account of the network-based computing system, the first snapshot corresponding to a first timestamp; receiving a second snapshot of the graph corresponding to a second timestamp different from the first timestamp; determining, based on the first and second snapshots, a first change in the graph; determining a second change in the graph related to the first change; detecting a potential anomaly based on the first and second changes; and responsive to said detecting a potential anomaly, causing a mitigation step to be performed with respect to the tenant account.

In a further example of the foregoing method, the graph comprises a first node and a second node. Said determining a first change in the graph comprises determining a change in the first node. Said determining a second change in the graph comprises determining a change in the second node.

In a further example of the foregoing method, the first node represents a user account of the tenant account and the second node represents a first resource of the tenant account. Said determining a change in the first node comprises determining the user account is granted access to the first resource.

In a further example of the foregoing method, said determining a change in the second node comprises determining the first resource is granted access to a second resource.

In a further example of the foregoing method, said detecting a potential anomaly comprises determining a severity level of the potential anomaly based on the first node, the second node, and an edge corresponding to the first and second nodes.

In a further example of the foregoing method, said detecting the potential anomaly comprises: determining a plurality of other changes in the graph different from to the first and second changes in the graph; determining a relationship between the first change in the graph, the second change in the graph, and the plurality of other changes; and determining the relationship satisfies a cumulative anomaly criterion.

In a further example of the foregoing method, said determining a first change in the graph comprises determining a level of access property of a user account associated with the tenant account has changed.

In a further example of the foregoing method, the method further comprises determining a number of new edges connected to a first node of the graph satisfies an anomaly criterion.

In a further example of the foregoing method, said determining a first change in the graph comprises determining a level of access property of a user account associated with the tenant account has changed.

In a further example of the foregoing method, the method further comprises detecting an amount of download activity associated with the user account satisfies an anomaly criterion.

In a further example of the foregoing method, the method further comprises receiving a third snapshot of the graph corresponding to a third timestamp different from the first timestamp and the second timestamp.

In a further example of the foregoing method, said determining the second change in the graph is based on the third snapshot.

A computer readable storage medium is described herein. The computer readable storage medium comprising programming instructions encoded thereon. The programming instructions structured to cause a processor to perform any of the foregoing methods.

### V. Conclusion

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

In the discussion, unless otherwise stated, adjectives modifying a condition or relationship characteristic of a feature or features of an implementation of the disclosure, should be understood to mean that the condition or characteristic is defined to within tolerances that are acceptable for operation of the implementation for an application for which it is intended. Furthermore, if the performance of an operation is described herein as being “in response to” one or more factors, it is to be understood that the one or more factors may be regarded as a sole contributing factor for causing the operation to occur or a contributing factor along with one or more additional factors for causing the operation to occur, and that the operation may occur at any time upon or after establishment of the one or more factors. Still further, where “based on” is used to indicate an effect being a result of an indicated cause, it is to be understood that the effect is not required to only result from the indicated cause, but that any number of possible additional causes may also contribute to the effect. Thus, as used herein, the term “based on” should be understood to be equivalent to the term “based at least on.”

Numerous example embodiments have been described above. Any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

Furthermore, example embodiments have been described above with respect to one or more running examples. Such running examples describe one or more particular implementations of the example embodiments; however, embodiments described herein are not limited to these particular implementations.

Moreover, according to the described embodiments and techniques, any components of systems, applications, computing devices, security systems, servers, storage devices, security graph generators, anomaly detectors, mitigators, and their functions may be caused to be activated for operation/performance thereof based on other operations, functions, actions, and/or the like, including initialization, completion, and/or performance of the operations, functions, actions, and/or the like.

Still further, several example embodiments have been described herein with respect to generating security graphs for the purpose of detecting potential anomalous activity. However, it is also contemplated herein that embodiments of graph generators and anomaly detectors can be used to monitor changes in data flow and data usage for data analytics in a network-based environment. Such embodiments could be used for identifying bugs in data flows or for recognizing data access paths that are no longer used or for identifying data access paths that have heavy traffic and need alternative paths to alleviate bandwidth.

In some example embodiments, one or more of the operations of the flowcharts described herein may not be performed. Moreover, operations in addition to or in lieu of the operations of the flowcharts described herein may be performed. Further, in some example embodiments, one or more of the operations of the flowcharts described herein may be performed out of order, in an alternate sequence, or partially (or completely) concurrently with each other or with other operations.

The embodiments described herein and/or any further systems, sub-systems, devices and/or components disclosed herein may be implemented in hardware (e.g., hardware logic/electrical circuitry), or any combination of hardware with software (computer program code configured to be executed in one or more processors or processing devices) and/or firmware.

While various embodiments have been described above, it should be understood that they have been presented by way of example only, and not limitation. It will be apparent to persons skilled in the relevant art that various changes in form and detail can be made therein without departing from the spirit and scope of the embodiments. Thus, the breadth and scope of the embodiments should not be limited by any of the above-described example embodiments, but should be defined only in accordance with the following claims and their equivalents.

What is claimed is:

1. A security system of a network-based computing system, comprising:
a processor:
a memory comprising program code structured to cause the processor to:
generate a first snapshot of a graph representative of a tenant account of the network-based computing system, the graph comprising a first node and a second node, the first snapshot corresponding to a first timestamp,
generate a second snapshot of the graph corresponding to a second timestamp different from the first timestamp,
determine, based on the first and second snapshots, a first change in the first node,
determine a second change in the second node, the second change related to the first change,
detect a potential anomaly based on the first change and the second change, and
responsive to the detection of the potential anomaly, cause a mitigation step to be performed with respect to the tenant account.

2. The security system of claim 1, wherein:
the first node represents a user account of the tenant account;
the second node represents a first resource of the tenant account; and
to determine the first change, the program code is further structured to cause the processor to determine the user account is granted access to the first resource.

3. The security system of claim 2, wherein to determine the second change, the program code is further structured to cause the processor to determine the first resource is granted access to a second resource.

4. The security system of claim 1, wherein to detect a potential anomaly, the program code is further structured to cause the processor to:
determine a severity level of the potential anomaly based on the first node, the second node, and an edge corresponding to the first and second nodes.

5. The security system of claim 1, wherein to detect the potential anomaly, the program code is further structured to cause the processor to:
determine a plurality of other changes in the graph different from the first change and the second change;
determine a relationship between the first change, the second change, and the plurality of other changes; and
determine the relationship satisfies a cumulative anomaly criterion.

6. The security system of claim 1, wherein to determine the first change, the program code is further structured to cause the processor to determine a level of access property of the first node has changed, and wherein the program code is further structured to cause the processor to:
determine a number of new edges connected to the first node of the graph satisfies an anomaly criterion.

7. The security system of claim 1, wherein to determine the first change, the program code is further structured to cause the processor to determine a level of access property of the first node of the graph has changed, and wherein the program code is further structured to cause the processor to:
detect an amount of download activity associated with the first node satisfies an anomaly criterion.

8. A method for mitigating anomalies in a network-based computing system, the method comprising:
receiving a first snapshot of a graph representative of a tenant account of the network-based computing system, the first snapshot corresponding to a first timestamp;
receiving a second snapshot of the graph corresponding to a second timestamp different from the first timestamp;
determining, based on the first and second snapshots, a first change in the graph;
determining a second change in the graph related to the first change;
detecting a potential anomaly based on the first change and the second change; and
responsive to said detecting a potential anomaly, causing a mitigation step to be performed with respect to the tenant account.

9. The method of claim 8, wherein:
the graph comprises a first node and a second node;
said determining the first change comprises determining a change in the first node; and
said determining the second change comprises determining a change in the second node.

10. The method of claim 9, wherein:
the first node represents a user account of the tenant account;
the second node represents a first resource of the tenant account; and
said determining the change in the first node comprises determining the user account is granted access to the first resource.

11. The method of claim 10, wherein said determining the change in the second node comprises:
determining the first resource is granted access to a second resource.

12. The method of claim 9, wherein said detecting a potential anomaly comprises:
determining a severity level of the potential anomaly based on the first node, the second node, and an edge corresponding to the first and second nodes.

13. The method of claim 8, wherein detecting the potential anomaly comprises:
determining a plurality of other changes in the graph different from the first change and the second change;
determining a relationship between the first change, the second change, and the plurality of other changes; and
determining the relationship satisfies a cumulative anomaly criterion.

14. The method of claim 8, wherein said determining the first change comprises determining a level of access property of a user account associated with the tenant account has changed; and
wherein the method further comprises determining a number of new edges connected to a first node of the graph satisfies an anomaly criterion.

15. The method of claim 8, wherein said determining the first change comprises determining a level of access property of a user account associated with the tenant account has changed; and
wherein the method further comprises detecting an amount of download activity associated with the user account satisfies an anomaly criterion.

16. The method of claim 8, further comprising:
receiving a third snapshot of the graph corresponding to a third timestamp different from the first timestamp and the second timestamp, and
wherein said determining the second change is based on the third snapshot.

17. A computer-readable storage medium encoded with program instructions structured to cause a processor circuit to perform a method comprising:
generating a graph representative of a tenant account of a network-based computing system, the graph comprising a first node and a second node;
detecting a first change in the first node at a first timestamp;
detecting a second change in the second node at a second timestamp, the second change related to the first change;
detect a potential anomaly based on the first change and the second change; and
responsive to the detection of the potential anomaly, cause a mitigation step to be performed with respect to the tenant account.

18. The computer-readable storage medium of claim 17, wherein:
the first node represents a user account of the tenant account;
the second node represents a first resource of the tenant account;
said determining the first change comprises determining the user account is granted access to the first resource; and
said determining the second change comprises determining the first resource is granted access to a second resource.

19. The computer-readable storage medium of claim 17, wherein said detecting a potential anomaly comprises:
determining a severity level of the potential anomaly based on the first node, the second node, and an edge corresponding to the first and second nodes.

20. The computer-readable storage medium of claim 17, wherein said detecting the potential anomaly comprises:
determining a plurality of other changes in the graph different from the first change and the second change;
determining a relationship between the first change, the second change, and the plurality of other changes; and
determining the relationship satisfies a cumulative anomaly criterion.
